(19) United States
(12) Patent Application Publication
(10) Pub. No.: US 2002/0104067 A1
(43) Pub. Date: Aug. 1, 2002

(54) Method and system and article of manufacture for an N-tier software component architecture application

(76) Inventors: David W. Green, Richmond, TX (US); Kevin L. Banks, Austin, TX (US); John W. Kiowski JR., Houston, TX (US)

Correspondence Address: Gary R. Maze, Duane, Morris & Heckscher LLP, Suite 500, One Greenway Plaza, Houston, TX, 77046, US

(21) Appl. No.: 09/746,157

(22) Filed: Dec. 22, 2000

Related U.S. Application Data
(60) Provisional application No. 60/173,914, filed on Dec. 29, 1999.

(51) Int. Cl. G06F 9/44

(52) U.S. Cl. 717/101; 717/107; 717/104

(57) ABSTRACT

A computing system for creating an extensible N-tiered software application is described, comprising at least one processing unit, at least one memory store operatively connected to the processing unit, extensible N-tiered software executable within the at least one processing unit, a communications pathway operatively connected to the processing unit, and at least one extensible tier capable of residing in the memory store, the tier further comprising a logically grouped set of a predetermined number of executable software components, each executable software component further comprising an external interface, each software component further capable of communicating with each other software component. A method for generating a software application in a computing system for creating an extensible N-tiered software application using the system comprises determining a set of application requirements and then, for each of the set of application requirements, reviewing the inventory of software components for software components that match at least one of the set of application requirements. For each application requirement in the set of application requirements for which a software component match does not exist in the software component inventory, a new software component is created to match that application requirement and then stored in the software component inventory. Each of the matching or new software components is associated with a respective tier of the predetermined set of tiers and the software application created by assembling the predetermined set of tiers.

### CROSS-REFERENCES TO RELATED APPLICATIONS

This nonprovisional U.S. national application, filed under 35 U.S.C. §111(a), claims, under 37 C.F.R. §1.78(a)(3), the benefit of the filing date of provisional U.S. national application no. 60/173,914, attorney docket no. D5407-00109, filed on Dec. 12, 1999 under 35 U.S.C. §111(b), the entirety of which is incorporated herein by reference. It has been proposed in co-pending U.S. patent application Ser. No. ______, attorney docket no. D5407-00109, filed on with a U.S. Express Mail number of ______ and incorporated herein by reference, to provide a system and method for software design of software architectures and, in particular, to provide for the design of a software component architecture for the development of extensible tier software component applications such as is used herein.

### BACKGROUND OF THE INVENTION

1. Field of the Invention

The present invention relates to development of software applications using software component architecture for the development of extensible N-tier software applications.

2. Description of the Related Art

A variety of techniques are used by a programmer or code developer to design or generate software program code. In one approach, software applications are designed as “monolithic” structures in which the various functions, such as data storage and application logic, are completely entwined. For example, given a set of system specifications and functions which are to be implemented by a given application or program, a code developer designs a monolithic, independently executable program which implements all the desired functions. The programmer may use, for example, a high-level programming language such as C++ and a code development tool to generate high-level language source code, which is compiled in turn by a compiler to provide an executable version of the program.

One problem with this approach is that the applications are difficult to maintain, and separate functional portions of the program are difficult to reuse because all portions of the program are entwined and application-specific.

Accordingly, in the software development arts various software architectures have been developed in which application functionality is broken down into smaller units, such as objects or components. These units may be assembled to provide the overall functionality for a desired application. For example, a group of components may be assembled and compiled to provide a stand-alone, executable program. Alternatively, the components may be invoked and used in real-time, when the component's functionality is needed.

Because of the resource expenditure necessary to develop these units, it is desirable to be able to reuse these units so that their functionality may be employed in subsequent applications without having to “re-invent the wheel” each time this functionality is needed. In current software architectures, such as two-tier and three-tier architectures, some portions, such as data repositories and user interfaces, are relatively easy to reuse. However, other types of components, such as those implementing application logic, are still clumped in large blocks, making reuse of these components or their various functions difficult. There is a need, therefore, for improved software component architectures and related software application and component development techniques that avoid the drawbacks of the prior art.

### BRIEF DESCRIPTION OF THE DRAWINGS

FIG. 1 is a diagrammatic representation of the present invention's “N-tier architecture” paradigm;

FIG. 2 is a pictographic representation of a software factory;

FIG. 3 is a diagrammatic representation of a framework;

FIG. 4 is a flowchart diagram of rules;

FIG. 5 is a flowchart representation of the present invention's life cycle rules;

FIG. 6 is a flowchart generally describing the present invention's method for designing a software architecture for use in generating software components;

FIG. 7, a Venn-type diagram of the present invention's Base Tier;

FIG. 8, a Venn-type diagram of the present invention's Messaging Tier;

FIG. 9, a Venn-type diagram of the present invention's business software components;

FIG. 10, a Venn-type diagram of composite components;

FIG. 11, a Venn-type diagram of the present invention's Real-Time Device tier;

FIG. 12, a Venn-type diagram of the present invention's Data tier;

FIG. 13, a Venn-type diagram of the present invention's Processing tier;

FIG. 14, a Venn-type diagram of the present invention's Visual tier;

FIG. 15, a Venn-type diagram of the present invention's Model-View-Controller (MVC) design pattern;

FIG. 16, a Venn-type diagram of the present invention's template objects;

FIG. 17, a Venn-type diagram of the present invention's Business Rules tier;

FIG. 18, a Venn-type diagram of the present invention's Interceptor tier;

FIG. 19, a Venn-type diagram of the present invention's Application tier;

FIG. 20, a Venn-type diagram of the present invention's Wizards tier; and

FIG. 21, a Venn-type diagram of the present invention's Testing tier.

### DETAILED DESCRIPTION

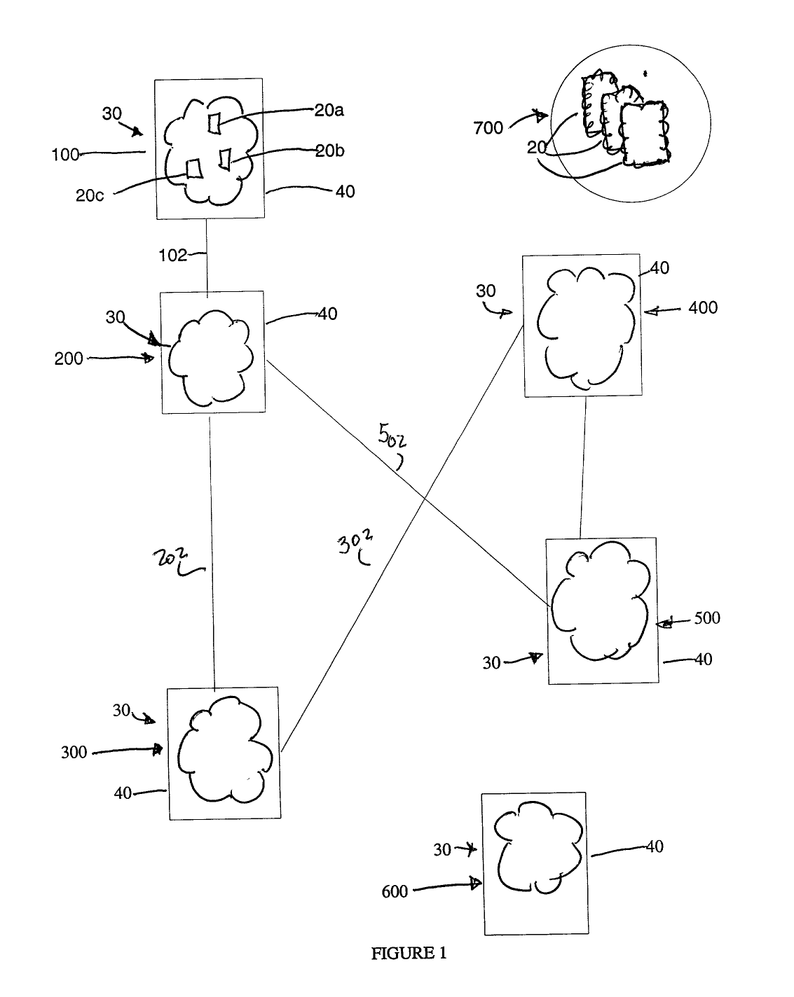

Referring generally to FIG. 1, the present invention comprises a methodology that applies an engineering and manufacturing oriented approach to software production based on a well-defined architecture. As used herein, “manufacturing” implies a method analogous to a software factory. Using the present invention methodology, software application development can proceed as if it was a software manufacturing process with an assembly line capable of assembling all types of intellectual property quickly and at the lowest cost.

The present invention uses an “N-tier architecture” paradigm. In an N-tier architecture, all functionality is broken down at the system level into logical chunks or tiers 30 that perform a well-defined business function. In the present invention's N-tier architecture there is no limit to the number of tiers 30.

The present invention's N-tier software design architecture is employed to develop software components 20. As those of ordinary skill in the programming arts will appreciate, “software components” are language independent and may be implemented in any of a number of computer languages including without limitation FORTRAN, C, C++, JAVA, assembler, or the like or any combination thereof. As those of ordinary skill in the programming arts will appreciate, “N-tier” in the prior art may be thought of as implying a hierarchy such as with protocol stacks. However, as used herein, “N-tier” describes an architecture that is characterized by a plurality of “N” tiers 30, each of which has a specified type and a specified interface. Although a hierarchy can be defined for the tiers 30, no one hierarchy is mandatory in the N-tier architecture of the present invention.

Each software component 20 to be developed is associated with at least one tier 30, depending upon the nature of the functions to be performed by that software component 20 and tier 30. The present invention specifies a method and a system for using architectures to implement a N-tier system wherein a software component designer can design or select each software component 20 to perform specified functionality and ensure that each software component 20 has the interfaces specified by the architecture for that tier 30.

Using the methodology of the present invention, there is no limit to the number of tiers 30 or software components 20 that can be implemented or defined. Rules for the architecture are used whereby tiers 30 are not necessarily part of a hierarchy as in two- or three-tier systems, but are logically interconnected using specified interfaces so that each tier 30 can interact with one or more other tiers 30 as needed, i.e., a software component 20 within a given tier 30 can interact with software components 20 of one or more other tiers 30 as necessary.

The following terms are understood to have the following meanings to those of ordinary skill in the software programming arts for the present invention, and some are further explained herein:

| TERM | DEFINITION |
|---|---|
| Architecture | A set of design principles and rules used to create a design. |
| COM | Component Object Modeling. |
| Component | An object that encapsulates, or hides, the details of how its |
| | functionality is implemented and has a well-defined |
| | interface reusable at a binary level. |
| CORBA | Common Object Request Broker Architecture |
| DCOM | Distributed Component Object Model |
| DLL | Dynamic Link Library |
| eventhandler | message handling object |
| Framework | An architected context for business objects that modify the |
| | business objects' attributes or add new behavior. |
| GUID | Globally unique identifier, e.g. a number having a |
| | predetermined number of bits that uniquely identifies a |
| | software component |
| JAVA | a programming language |
| Model | A heterogeneous collection of components whose relation- |
| | ships are enforced via a predetermined set of rules; a |
| | collection or instantiation of software components where |
| | the collection or instantiation may be organized into a |
| | hierarchy |
| Object | A programming structure encapsulating both data and |
| | functionality that are defined and allocated as a single unit |
| | and for which the only public access is through the |
| | programming structure's interfaces. A COM object must |
| | support, at a minimum, the IUnknown interface, which |
| | maintains the object's existence while it is being used |
| | and provides access to the object's other interfaces. |
| Package | A logical grouping of interfaces within a framework that |
| | provide a specific behavior such as messaging or |
| | connecting. |
| Sink | Connection sink for messaging. |
| Source | Connection source for messaging |
| Tier | A logical grouping of components that perform a well- |
| | defined, predetermined function. |

As further used herein, “manipulates” is meant to be read in an inclusive manner to include a software application that passively models, actively models, or performs a combination of active and passive modeling. Further, a software application that “manipulates” also includes software applications that perform data processing, data acquisition, and supervisory control functions as those terms are understood by those of ordinary skill in the software programming arts.

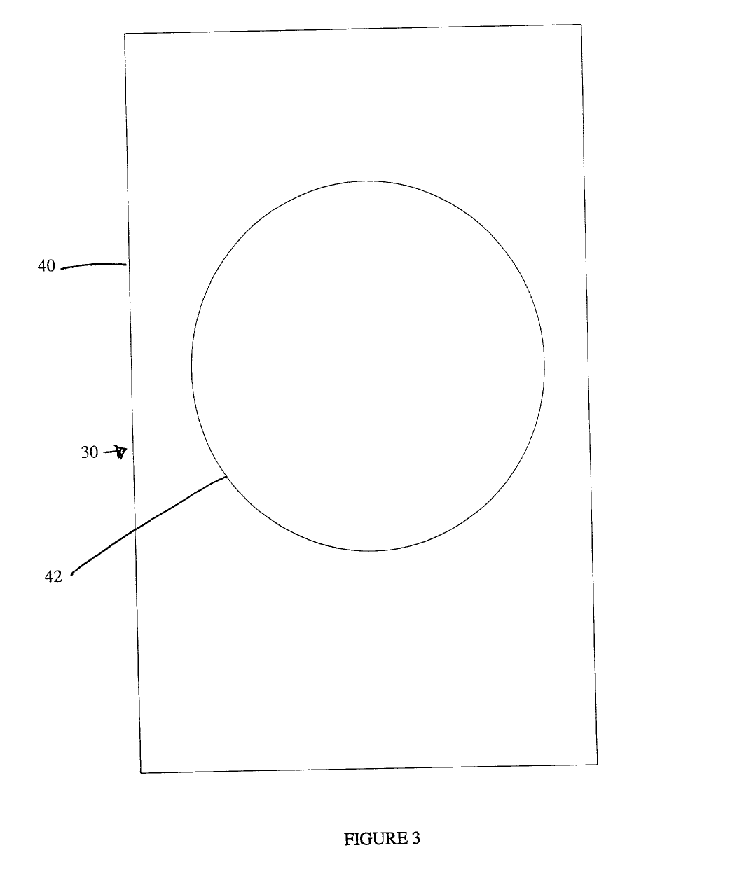

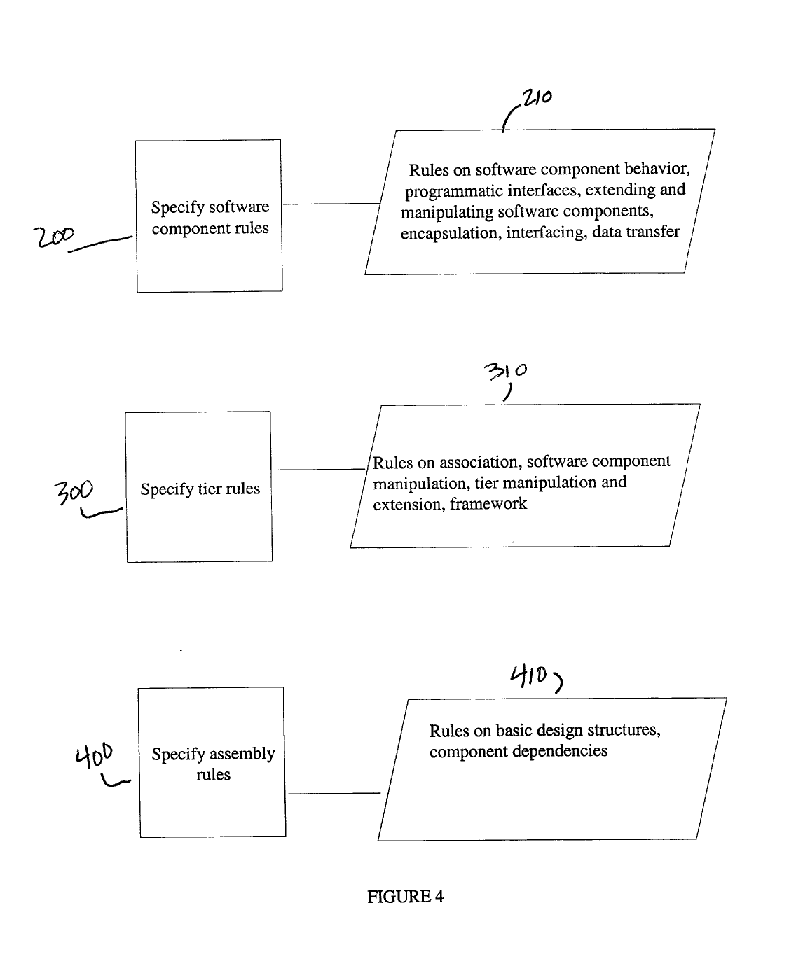

Frameworks 40 specify a basic design structure for a tier 30, including software components 20 and a set of standard interfaces for any software component 20 categorized as belonging to that tier 30. As indicated in FIG. 1 through FIG. 21, frameworks 40, shown generally as boxes, comprise one or more packages 42, shown generally as circles in the various figures; one or more representative interfaces, where the interfaces are shown generally as clouds in the various figures; and one or more methods for collecting software components 20 as well as one or more interrogatable properties and variables. A package 42 is thus a collection of interfaces that provide a specific behavior, such as messaging or connecting. Most frameworks 40 in the present invention comprise more than one package 42.

In object oriented software programming arts, methods and properties are often referred to as attributes, but frameworks 40, packages 42, and interfaces are not limited to object oriented programming constructs. As used herein, “methods” are meant to mean software that exhibits a behavior and “properties” are meant to mean variables and constants exposed to other interfaces.

As further used herein, a “collection” or “software collection” is a software construct that provides an interface that allows access to a group of data items, whether raw data or other software components 20. An interface that follows the standards for providing access to a group of objects is referred to herein as a “collection interface.” By way of example and not limitation, a collection interface provides programmatic access to a single item in the collection such as by a particular method, e.g. an “Item( )” method. By way of further example and not limitation, a collection interface lets “clients,” as that term is understood by those of ordinary skill in the software programming arts, discover characteristics, e.g. how many items are in the collection, via a property, e.g. a “Count” property.

Throughout this document, references to different kinds of software components 20 will use the following naming conventions:

TABLE 1
Standard Abbreviations

| Abbreviation | Definition |
|---|---|
| GC | Class |
| GP | Package |
| IGC | Interface to Class |

Thus, within this specification an entity, construct, or named example such as “GCxxx” implies that “GCxxx” may be implemented as a class as that term is understood by those of ordinary skill in the software programming arts. An entity, construct, or named example such as “IGCxxx” implies that “IGCxxx” is an interface to a class as that term is understood by those of ordinary skill in the software programming arts. An entity, construct, or named example such as “GPxxx” implies that “GPxxx” is a package 42. This terms and naming conventions are meant to be illustrative and are not meant to be limiting as software components 20 may be implemented in other than software that uses the notion of “class,” e.g. object oriented programming languages.

In addition, software components 20 may comprise properties or attributes. As used herein, a property indicated with a name having a trailing set of parentheses “( )” is to be understood to be an invocable method, whereas a property indicated with a name without a trailing set of parentheses “( )” is to be understood to be a variable or other datum point. By way of example and not limitation, those of ordinary skill in the programming arts will understand that an object or software component 20 named “foo” may have a method “add( )” invocable by “foo.add( )” and a property “grex” accessible by “foo.grex” or in similar manner. As will be readily understood by those skilled in the software programming arts, two or more software components 20 may have identically named methods or properties, but each represents a unique and distinct method or property. For example, an interface “IGOne” may have a property “x” as may an interface “IGTwo,” but IGOne.x is not the same as IGTwo.x. Similarly, IGOne.foo( ) is not the same as IGTwo.foo( ).

It is understood that these descriptive constructs are not limitations of the present invention, the scope of which is as set forth in the claims, but are rather meant to help one of ordinary skill in the software programming arts more readily understand the present invention. In addition, more information on these functions and naming conventions, and on software components and COM objects in general, can be found in the MSDN (Microsoft Developer's Network) Library (January 1999), published by Microsoft Press and incorporated herein by reference.

It is further understood that, as used herein, “software components,” generally referred to by the numeral “20,” include objects such as are used in object oriented programming, as these terms are readily understood by those of ordinary skill in the software programming arts, but are not limited to objects. Instead, software components 20 may further comprise any invocable software including runtime libraries, dynamic link libraries, protocol handlers, system services, class libraries, third party software components and libraries, and the like, or any combination thereof.

A given N-tier application may be designed using the principles, rules, and methods of the present invention to satisfy the needs and characteristics of a given industry. As used herein, “application” is understood to include compiled, interpreted, and on-the-fly applications, such as, by way of example and not limitation, CORBA, just-in-time, JAVA, and the like, or any combination thereof, as these terms are understood by those of ordinary skill in the software programming arts. A “wizard” or other code development tool may also be used which allows the code developer to generate software components 20 within the specifications of the particular N-tier architecture. For example, the wizard may permit the code designer to generate a software component 20 by selecting the tier 30 for the software component 20 and ensuring that the software component 20 is in compliance with the interface standards designated for software components 20 of that particular tier 30.

An N-tier application defined and implemented using the present invention may be thus adapted for use in numerous industries and contexts, for example ship-building arts, financial arts, or medical arts as well as geological industry arts.

Referring now generally to FIG. 1 through FIG. 21, an N-tier application of the present invention is designed using an extensible N-tier architecture developed using a methodology for specifying rules and methods that enable applications to be constructed. Such a methodology has been proposed in co-pending U.S. patent application Ser. No. ______, attorney docket no. D5407-00109, filed on with a U.S. Express Mail number of ______ and incorporated herein by reference.

Such applications have functionality broken down at the system level into logical chunks or tiers 30 that perform a well-defined function, such as a business function, according to rules for the selected architecture. In a currently preferred embodiment, each tier 30 logically groups together software components 20 that have a similar or complementary type of behavior.

As discussed herein below, framework 40 specifies a basic design paradigm for a tier 30, including a base set of software components 20 and a set of standard interfaces for any software component 20 categorized as belonging to that tier 30. Frameworks 40 may comprise a plurality of packages 42.

The present invention uses predetermined rules to allow new software components 20 to be created or purchased and then possibly added to an inventory (or catalog) 700 of components for future reuse in subsequent applications. As more software components 20 are developed, inventory 700 grows, thus further reducing the time and resources needed to develop new applications. Further, software components 20 are available for use by any other software component 20 that can use its interface, including off-the-shelf components. Off-the-shelf components, e.g. purchased components, may be incorporated into the N-tier application of the present invention such as by adding a predetermined interface to that off-the-shelf component as required by the N-tier architecture of the present invention.

The present invention also uses predetermined rules to allow a given N-tier application to be extended, for example by adding a new tier 30 to result in a new, N+1-tier application. Many software components 20 developed for the predecessor N-tier application will be immediately reusable in the incremental, N+1-tier application and others will be reusable with relatively minor modifications.

Each tier 30 defined and implemented using the present invention specifies the types of interfaces that software components 20 associated with that tier 30 must have. These interfaces are thus standardized interfaces for that N-tier architecture that allow software components 20 of a type of tier 30 to be accessed by other software components 20 in other tiers 30. A software component designer using the present invention uses the rules for building software components 20 with the knowledge of or ability to access other software components 20, based on the interface specified by tier 30 for these types of software components 20.

In one embodiment, the present invention uses predetermined rules to define and create a particular N-tier application with a specified, initial number and type of tiers 30 and with a specified interface architecture for each tier 30, where each initial tier 30 satisfies one of a major portion of system functionality, such as business logic processing, data processing, and the like.

Each tier 30 will tend to have a unique set of interfaces, depending on the nature of the types of software components 20 grouped under that tier 30. More common interfaces may include a specific, common first interface to allow a software component's 20 dependencies to be collected by that software component 20 and accessed by other components; and a specific, common second interface to allow a software component 20 to be identified at run time by another component.

In an embodiment, the N-tier application of the present invention may utilize an asynchronous architecture paradigm permitting software components 20 to engage in asynchronous communication via asynchronous messaging. In other embodiment, synchronous or mixed synchronous and asynchronous messaging may be present.

In a currently preferred embodiment, software component 20 interfaces are implemented using Microsoft's COM specification for its WINDOWS (R) operating system environment. See, e.g., ESSENTIAL COM by Don Box, published by ADDISON WESLEY LONGMAN, INC., 1998 with ISBN Number 0-201-63446-5. Only a software component's 20 external interfaces are seen by the outside world. Common interaction standards, such as ActiveX, may be used to facilitate communication between software components 20 and reduce the need for connective software between software components 20. Services provided by software components 20 may then be networked together to support one or more desired processes. These services can be reused and shared by other software components 20. However, it will be apparent to those of ordinary skill in the programming arts that software components 20 may be constructed using numerous other environmental paradigms, by way of example and not limitation including those required by LINUX, SUN (R) SOLARIS (R), Unix, or the like, or any combination thereof.

As currently contemplated, some tiers 30 may exist that are not true tiers 30, i.e. they do not exist to provide additional behavior to software components 20. These tiers 30, such as Wizard, Testing, or Template tiers 30, shown generally in FIG. 1 as tier 600, may be present to provide additional auxiliary functionality. By way of example and not limitation, Wizard tier 30 may exist to provide a set of interactive help utilities that assists developers in quickly creating standard present invention components. Testing tier 30 may be present to contain software components 20 that exercise software components 20 or packages 42 from the functional tiers 30, record test results in a log, and notify developers of the test completion status. Software components 20 in Template tier 30 may provide C++ implementation of persistence, collections, and iterators for standard present invention software components.

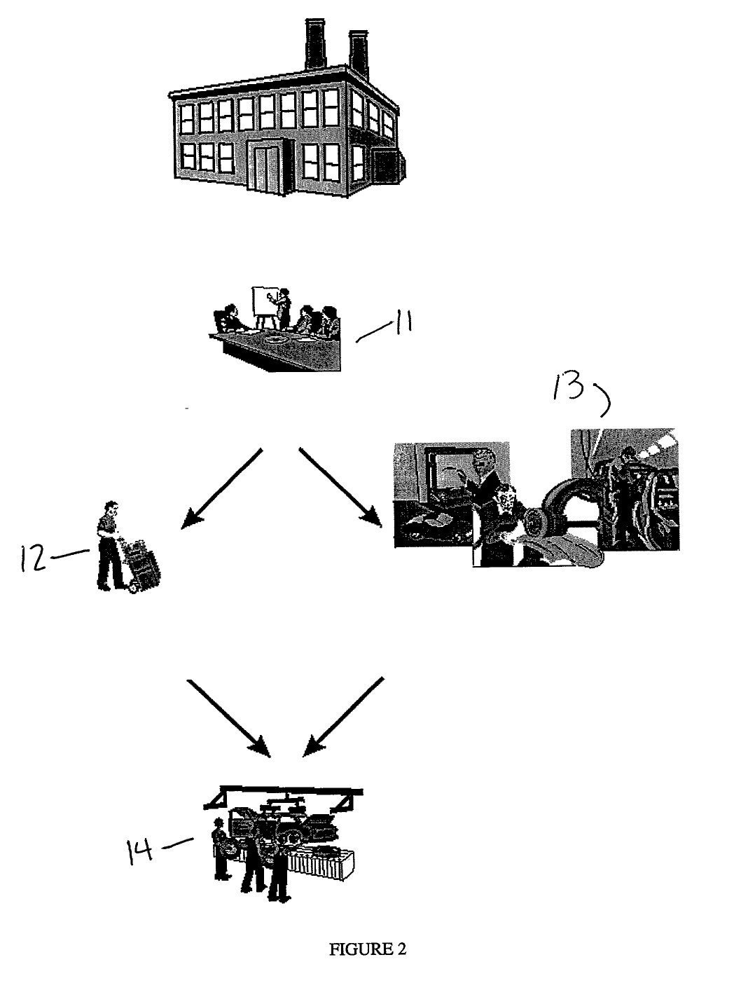

Referring now to FIG. 2, a pictographic representation of a software factory, software components 20, whether purchased or created, may be placed into inventory 700 for future use using library or cataloging processes, all of which are familiar to those of ordinary skill in the programming arts. Software component 20 interfaces are standardized, with software component 20 functionality limited to the characteristics and behavior unique to the software components they represent. The paradigm for the present invention is a software application assembly line as if in a software application factory. As shown at 11, application requirements are first determined. The existing inventory 700 is then reviewed 12 for software components 20 that fit the new application requirements. System requirements that do not exist as stock software components 20 are created 13 or possibly purchased and possibly added to inventory 700. A new application may then be created 14 from the stock software components 20 and the new software components 20. The application may be created by combining software components 20 at run-time to form new unique applications on-the-fly, and making software reuse a practical reality.

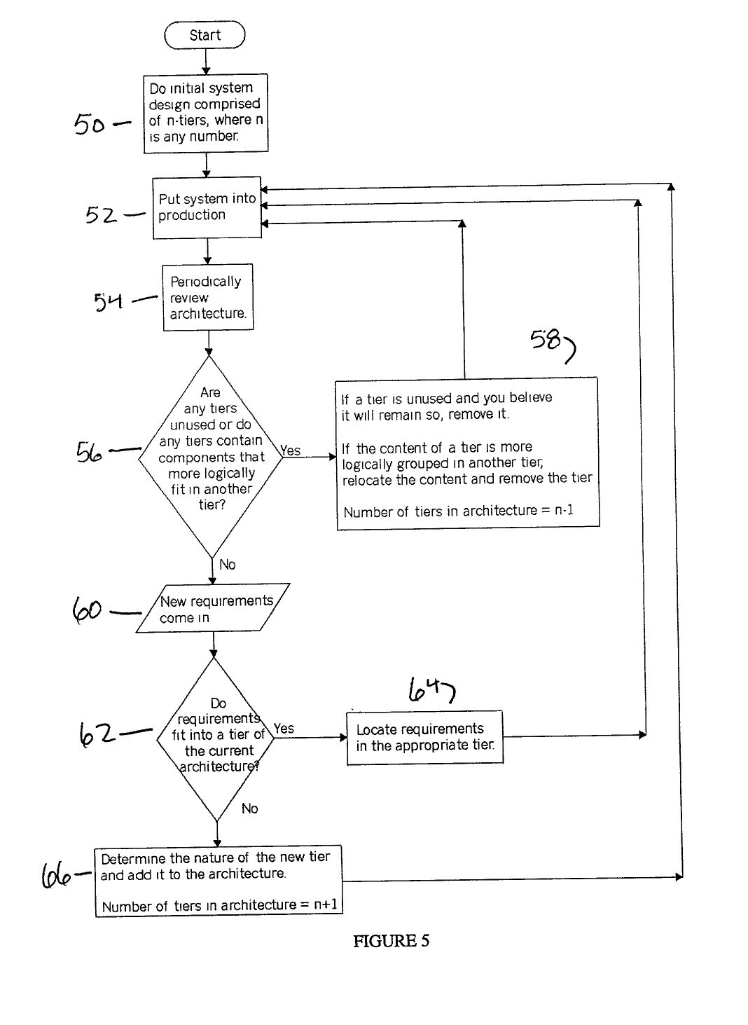

Referring now to FIG. 5, a life cycle flowchart, the present invention's methodology allows application development to drive changes to the present invention's architecture using a set of life cycle rules. By way of example and not limitation, rules that define that software architecture are either designed anew, selected from a preexisting set of rules, or any combination thereof. Thus, a software application designed using the present invention's method generates software components 20, tiers 30, and applications by using software component rules 210, tier rules 310, and assembly rules 410 for an initial design 50. The initial design may have a predetermined number of initial tiers 30.

The system implemented is put into production 52 and periodically reviewed for adjustments that may be necessary 54. If any tier 30 is determined to be in need of adjustment 56, it can be removed or otherwise modified 58. As additional requirements arise 60, new software components 20 are created, existing software components 20 modified 62, 64, or a combination thereof. Tiers 30 may be added, modified, or deleted 66 as application requirements dictate.

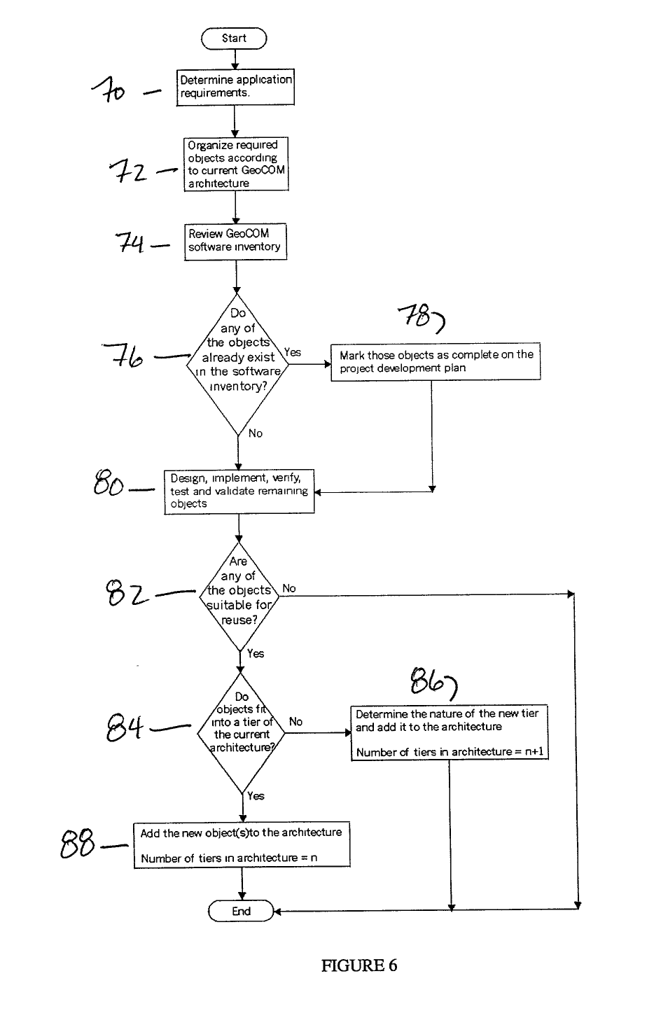

Referring now to FIG. 6, once a list of required models 31 and software components 20 is determined 70, software components 20 are logically grouped 72. A determination 74, 76 is then made to determine if any of the needed software components 20 already exist in inventory 700. Whenever possible, software components 20 are reused 78 from inventory 700. Software components 20 that do not fit the current architecture may be restructured to ensure conformance while retaining the original intent of the requirement.

Additional software components 20 may be created or purchased 80 as needed after review of specifications and current inventory 700.

Using the predetermined rules and design methods of the present invention, software components 20 are designed and implemented as needed for a given functionality. By way of example and not limitation, business software components 20 may be defined and implemented where each business software component 20 encapsulates information about a real-world object or process, such as a well, a geological feature under the earth (e.g. a fault), a logging truck or tool, or information about a job that has been run. Visual software components 20 may be defined and implemented to encapsulate presentation information. By way of further example and not limitation, data software components 20 may also be defined and implemented as a software component 20 that preserves the state of a business software component 20 and allows data within a business software component 20 to be accessed and used. For example, a data software component 20 may extract data from a given business software component 20 and store it in a database.

After new or modified software components 20 successfully pass a testing and validation phase, new or modified software components 20 are assessed for suitability 82 to become part of inventory 700. Software components 20 that have potential for reuse are added 88 to inventory 700. These new or modified software components 20 may thus be integrated into a current architecture, expanding the current architecture, i.e., adding 86 one or more tiers 30 to accommodate them. By definition via the rigid implementation of standard interfaces, a software component 20 from one tier 30 can be used by any software component 20 from any other tier, making tier 30 relationships of little importance. However, in practice it is likely that certain software components 20 will primarily be used by certain other software components 20.

As illustrated in FIG. 1, each of present invention's tiers 30 may interface with one or more other tiers 30 using an interface mechanism as further described and claimed herein. By way of example and not limitation, in one embodiment of the present invention, the present invention's design methodology specifies a predetermined, initial number of tiers 30 comprising Base tier 1000. Base tier 1000 software components 20 may then be used to create software components 20 and other tiers 30, by way of example and not limitation such as Messaging tier 2000, Business Object tier 3000, Real-Time Device tier 4000, Data tier 5000, Processing tier 6000, Visual tier 7000, Template tier 8000, Business Rules tier 9000, Wizards tier 10000, Testing tier 11000, Interceptor tier 12000, and Application tier 13000. Other tiers 30 may also be created, such as by way of example and not limitation Plotting tier 30.

Referring now to FIG. 7, Base tier 1000 may be present to provide initial, basic mechanisms for implementing an application. In a preferred embodiment, Base tier 1000 software components 20 form tailorable, initial building blocks for other software components 20 and other tiers 30.

Base tier 1000 comprises GPCollection 1100, which provides a method for collecting software components 20; GPBase 1200, which contains several software components which are normally aggregated into other software components 20; GPConnection 1300, which provides methods for connecting software components 20 as sources or sinks of information, where source and sink have the meanings as described herein below; GPEventHandler 1400, which provides the message-based, asynchronous behavior; and GPDevice 1500, which provides methods for controlling devices.

GPCollection 1100 allows accessing a group of data items, e.g. a set of oil well data curves. In a preferred embodiment, GPCollection 1100 comprises methods that enable access to and maintenance of a data set and is an implementation of a COM collection interface, including determining the number of and allowing iteration through software components 20 in a collection. In the preferred embodiment, these methods provide access to a specific item by its ordinal position in a collection as well as by one or more of a predetermined type of identifier, e.g. a name.

GPBase 1200 supports software components 20 that are used by most other software components 20, for example, to get or set the time and date as well as assignment of a predetermined category characteristic to a software component 20. The category characteristic property may allow getting or setting descriptive information about a software component 20, including the registered number (CLSID) of software component 20 and a “type characteristic” of a software component 20 where type characteristics may be different for different software components 20 and where type characteristics are predefined or programmatically defined. For example, “business” software components 20 might have a type of “curve” or “well,” and “data” software components 20 might have a type of “curve” or “parameter.”

GPConnection 1300 implements COM connection point behavior. As will be understood by those of ordinary skill in the software arts, a “connection” has two parts: the software component 20 invoking the interface (called the “source”) and the software component 20 implementing the interface (called the “sink”). A “connection point” is the interface exposed by the source. By exposing a connection point, a source allows one or more sinks to establish connections to that source.

In the present invention, one or more GPConnection 1300 methods allow passage of an interface, as that term is readily understood by those in the software programming arts, from the sink to the source. This interface provides the source with access to the sink's implementation of a set of member functions. For example, to fire an event implemented by the sink, the source can call the appropriate method of the sink's implementation. In the currently preferred embodiment, only GCMessage 1340 (not shown in the Figures), comprising a message that can contain anything from a text string to a pointer to a large amount of data, can be sent between the sink and the source.

GPConnection 1300 comprises one or more interfaces to enable sending and receiving events or information to another software component 20. In the preferred embodiment, a designer must aggregate a connection source interface into any software component 20 that needs to send events or information to another software component 20, e.g. a message, or that needs to support sink interfaces.

GPEventHandler 1400 executes previously registered callbacks between a framework 40 and applications built on top of the framework 40. GPEventHandler 1400 comprises interfaces that support event processing, including event-handling services capable of handling synchronous or asynchronous events, thread pool services to manipulate and maintain a pre-set number of threads; and methods to provide callback processing on an event and to track which callbacks are registered to handle which message types.

Each callback handles only one message type, and an interface is used inside the event handler to track which callbacks are registered to handle which message types.

GPDevice 1500 allows communication with hardware devices. GPDevice 1500 comprises interfaces to provide for communication to and from hardware devices as well as interfaces to let an event handler send information or events back to a device.

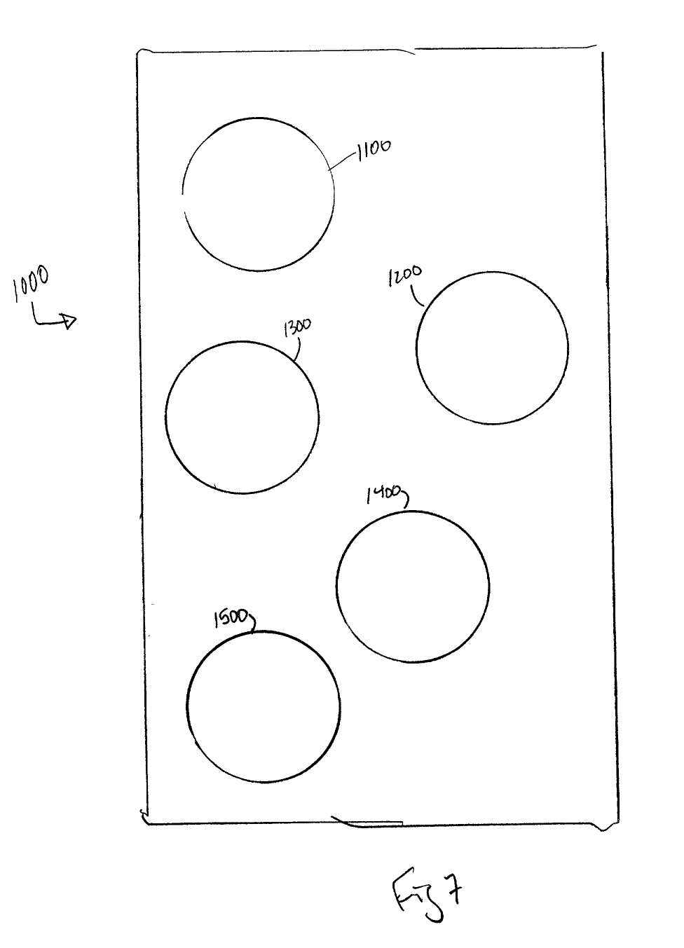

Referring now to FIG. 8, Messaging Tier 2000 software components 20 convey information, in the form of other software components 20 such as business software components 20, to a recipient. For example, in the preferred embodiment messaging software components 20 control asynchronous message queuing and notification. Messaging Tier 2000 comprises three packages: GPMessage 2100, that handles message generation; GPMessageQueue 2200, that handles message queuing; and GPRouter 2300, that handles message routing.

GPMessage 2100 adds interfaces that support message generation for different types of messages, including interfaces to manage the message data or information and to specify the software component 20 that will receive the message, for example, a software component's 20 sink interface. Additionally, GPMessage 2100 may provide interfaces to provide a set or collection of destination software components 20, for example multiple software component 20 sink interfaces and/or to contain information about a specific queue.

In a preferred embodiment, GPMessage 2100 is the standard information packet, i.e., the body of the message, contains an Unknown 1302 interface (not shown in the Figures) to the body of the message and aggregates IGCType 1230 to identify the message type.

Further, in a preferred embodiment, the interface that specifies a destination software component 20 supports either sink or message queue interfaces as well as stores timing information for routing analysis. These include support for message routing to one or more service destinations. The message queue interface accepts messages and queues them asynchronously as well as notifies registered users of a queue that the queue contents have changed.

GPRouter 2300 decides whether to send a message asynchronously via a message queue or synchronously via a direct call on the sink, and comprises an interface that examines the route a message can take to reach its destination and determines whether to send the message directly to the sink or send it to the message queue to be routed asynchronously.

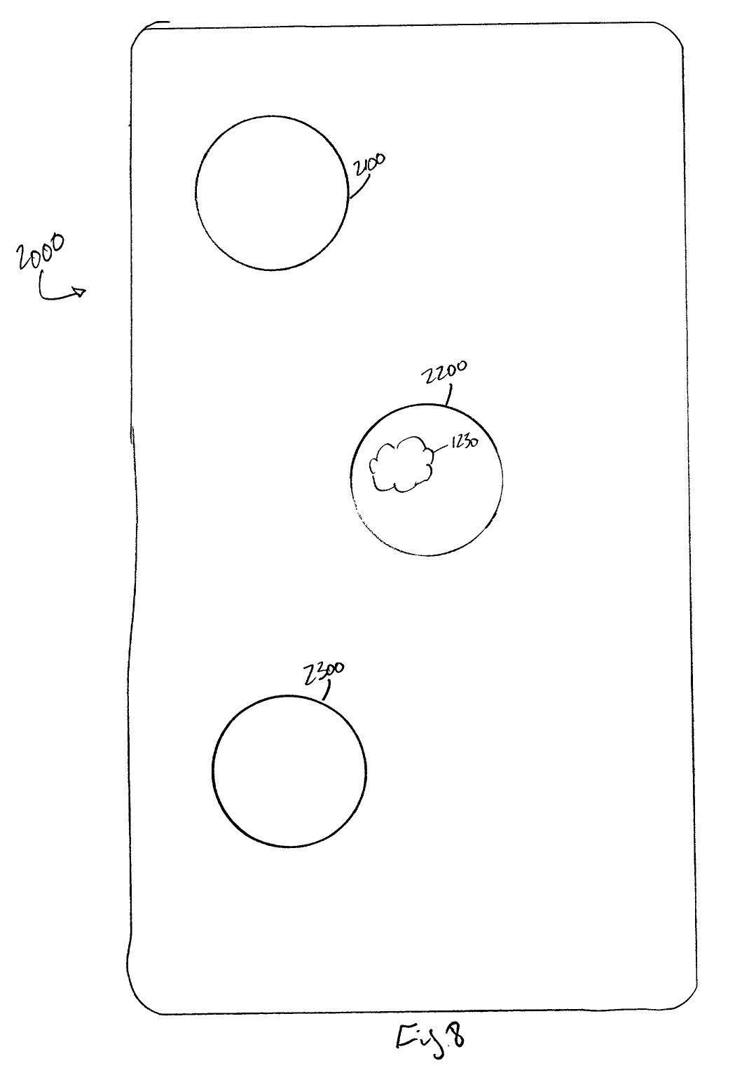

Referring now to FIG. 9, in a preferred embodiment, Business Object tier 3000 specifies base interfaces used to create business software components 20. In the preferred embodiment, business software components 20 provide storage for and access to information, encapsulating the attributes and methods of a common business entity, such as a well, log, sensor, or bed.

Thus, a business software component 20 may represent real-world business data, such as a well, log, gamma ray measurement, resistivity measurement, job, run, pass, sensor, STAR tool, fracture, fault, bed, bedding surface, or borehole. Business software components 20 contain many attributes and methods used to access the data but contain little additional behavior.

Rather than try to model all the possible associations of business software components 20 and create a static business software component model 31, in the preferred embodiment business software components 20 have a generalized collection interface used to collect other business software components 20. Valid types of business software components 20 that can be collected by (or associated with) other business software components 20 are defined external to the business software components 20 in Business Rules tier 9000. This allows business software components 20 to be maintained separately from the rules defining their relationships. This also lets the relationships change without changing business software components 20.

For example, business rules may allow a set of business software components 20 to be associated with a defined model 31. If a new business software component 20 is defined, a simple update to a rules database would allow its associations to be defined as well. Therefore, business rules could be updated to allow the new business software component 20 to be associated with the existing model 31, and none of the existing business software components 20 would need to be changed or rebuilt.

By building meaningful associations of business software components 20, software components 20 model real-world business needs. Using business software components 20 as “black-box” data containers, software components 20 can implement additional behavior to visually render, analyze, or modify model 31.

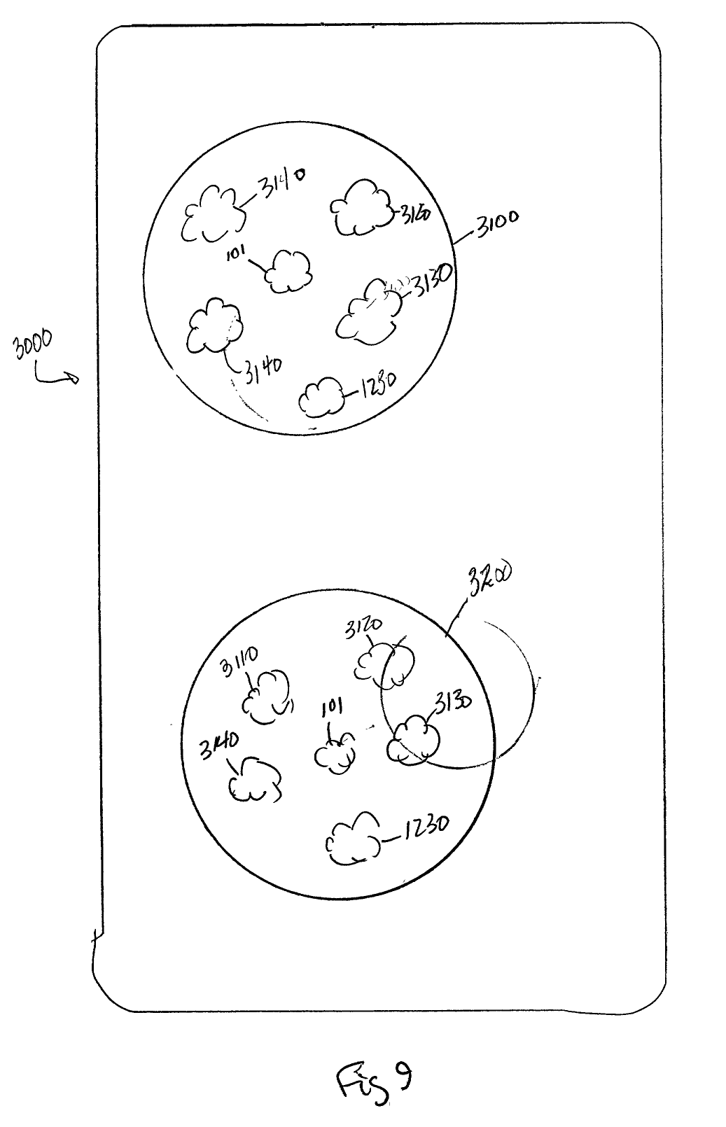

Referring now to FIG. 10, composition software components, some business software components 20 may be “compositions,” business software components 20 that have attributes that are other business software components 20. In the case of compositions, a composite business software component 20 is static—the relationship between business software component 20 and the attribute software component 20 is not an association enforced by business rules. Compositions may be used when there is a “whole-to-part” relationship between software components 20; by way of example and not limitation, in an exemplary embodiment for an oil well, composite business software component 20 GCBed 3010 comprises a top GCBeddingSurface 3011 and bottom GCBeddingSurface 3012. These surface software components 20 are a critical part of GCBed 3010 in that GCBed 3010 cannot accurately be defined without them. Therefore, GCBed 3010 is a composite business software component 20 further comprising two attributes, GCBeddingSurfaces 3011, which are themselves business software components 20. Methods may then be provided on a business software component 20 to access the composite business software components 20.

Composite business software components 20 are not created when a new business software component 20 is created. It is therefore the responsibility of the system designer to create any business software components 20 that comprise each composite business software component 20 and set them into the composite software component 20. In the preferred embodiment, when business software components 20 are retrieved from a persistent store, composite business software components 20 are automatically retrieved.

Every business software component 20 has a business software component interface to support access to the encapsulated data. Business software components 20 are implemented as standard dual interface COM components, meaning they support both IUnknown 1302 interface needed for languages that support early binding such as C++, and IDispatch 1303 needed by languages that support late binding like Visual Basic. Business software components 20 may be designed and tested to be used with either interface or both interfaces which allows them to be used in multiple container types supported by, for example, C++, Visual Basic, Java, scripting languages, or Web Browser automation, or any combination thereof.

In addition to the standard COM interfaces, other standard interfaces may exist on business software components 20, some of which may be optional and others required. For example, business software components 20 are often central to an application and need to be accessed by other software components 20 in numerous tiers 30. Therefore, there is usually a business software component 20 interface as well as some additional interfaces present in a present invention application. However, business software components 20 do not usually need to access many other software components 20.

Referring back to FIG. 9, additional interfaces may provide a base level of functionality for all business software components 20. All business software components 20 support the following required interfaces: IGCAssociations 3110, that lets software components 20 have other software components 20 associated with them; IGCAttributes 3140, that lets users of business software components 20 determine persistable attribute names of business software components 20, e.g. allowing persistable attribute names to be written to a data store and retrieved at a future time; IGCObject 3130, that allows for dumping the contents of software components 20; IGCParents 3120, that lets software components 20 establish and maintain hierarchical relationships with other software components 20; IGCType 1230; and IPersistStream 101, a standard Microsoft COM interface. In addition, all business software components 20 provide a standard, unique ID (GUID).

In addition, software components 20 can use these interfaces to implement new behavior. For example, rather than writing a routine to traverse a model 31 looking for every possible business software component 20 interface, program logic can traverse the model 31 by programmatically obtaining IGCType 1230 from each software component 20 and examining the message returned. One way to accomplish this traversal may be to use a template iterator class to facilitate accessing associations.

Business Object tier 3000 software components are easily extensible. Because business software components 20 are COM components designed to have no dependencies, new attributes and behavior can readily be added to one business software component 20 or to all business software components 20 with little or no modification to existing code.

In a preferred embodiment, Business Object tier 3000 comprises: GPModel 3100, allowing collection of a group of related business software components 20 into a real-world business entity called a model; and GPBLOB 3200, allowing storage of large amounts of binary data in a business software component 20.

GPModel 3100 comprises a set of interfaces that business software components 20 aggregate to achieve specific functionality.

GPBLOB 3200 provides interfaces that supply information about large amounts of binary data stored in business software components 20. These interfaces are optional and used only when the number of instances of a business software component 20 is very large. For example, a group of logging measurements could be collected into a GPBLOB 3200 describing a section of a well log. As is well understood by those of ordinary skill in the programming arts, “BLOB” is an acronym for binary large object.

Referring now to FIG. 11, Real-Time Device tier 4000 supports communication with and event handling for a real-time device, such as from a down-hole logging tool to a computer on a truck. Real-Time Device tier 4000 comprises GPRealTime 4100 to support standard communication and event-handling interfaces that allow a device to communicate with other connected software components 20, including interfaces to provide methods for allowing a user to register a real-time device with another real-time device.

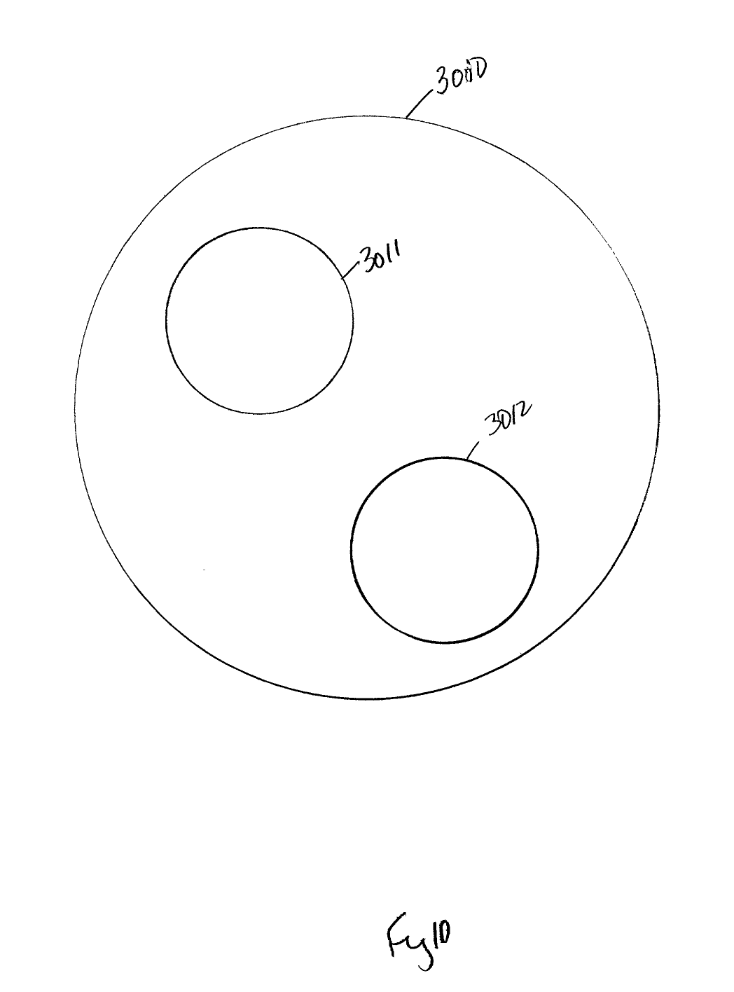

Referring now to FIG. 12, Data tier 5000 provides data persistence services for business software components 20. Data tier 5000 also provides access to data. Data tier 5000 comprises: GPPersist 5100, that lets data be written to and read from a data source, and GPDataAccess 5200, that provides access to specific types of data.

In a preferred embodiment, GPDataAccess 5200 comprises: GPDataFormat 52100, that provides business software component 20 persistence for a specific data format; GPDataService 52200, used to build software components 20 that hold a list of registered data formats available; GPWindowedIO 52300, that establishes the requirements for information a software component 20 is retrieving from a data service; GPDataIO 52400, used for low-level hardware device (e.g. disk and tape) input/output (“I/O”) access; GPUnitsConverter( ) 52500, used for data conversion from one measurement system to another; and GPDataDictionary 52600, that provides data identity and naming conventions for information retrieved from a data file. It is important to note that, as exemplified by GPDataAccess 5200, a feature of the present invention's architecture allows a package such as GPDataAccess 5200 to comprise other packages such as GPDataFormat 52110.

In a preferred embodiment, GPDataFormat 52100 provides business software component 20 persistence to a format known by a specific data-format software component 20 and comprises an interface to support business software component 20 persistence for a particular file format to allow generic message handlers to call specific functions as well as an interface to provide standard messaging for sending and receiving by business software components 20. In the preferred embodiment, IGCBaseDataFormat 51210 is an interface that must be implemented for a data-format software component 20, and comprises the properties that allow manipulation of devices and data according to a predetermined format. In the preferred embodiment, IGCBaseDataFormat 51210 comprises IGCDataFormat 52120 that must be aggregated for a data-format software component 20 to provide standard messaging for sending and receiving by business software components 20.

In a preferred embodiment, GPDataService 52200 may be used to build software components 20 that hold a list of registered data formats available for read or write access.

In a preferred embodiment, GPWindowedIO 52300 specifies the requirements for information a software component 20 is retrieving from a data service. GPWindowedIO 52300 comprises IGCWindowedIO 52310 that specifies the requirements for information a software component 20 is retrieving from a data service. In a currently preferred embodiment, IGCWindowedIO 52310 comprises: OffsetFromCurrent 52311, this windowed I/O interval's offset from the main set's current working level data, if any; TopOffset 52312, the interval's top offset in levels from its current working level; BottomOffset 52313, the interval's bottom offset in levels from its current working level; Increment 52314, the level spacing to return in the given interval; ResampleType 52315, describes the actions to perform when a level spacing of data sets does not match; TopBoundType 52316, indicates what happens to the data above the current working level, e.g. when a curve interval is iterated off the beginning/end of the data or over a NULL value; BottomBoundType 52317, indicates what happens to the data below the current working level, e.g. when a curve interval is iterated off the beginning/end of the data or over a NULL value; DataType 52318, the returned data type; and AccessType 52319, e.g. either random or sequential access.

In a preferred embodiment, GPDataIO 52400 specifies interfaces for low-level device (e.g., disk and tape) I/O access, GPUnitsConverter 52500 comprises interfaces used for data conversion from one measurement system to another, and GPDataDictionary 52600 comprises interfaces for components that provide data identity and naming conventions for information retrieved from a data file.

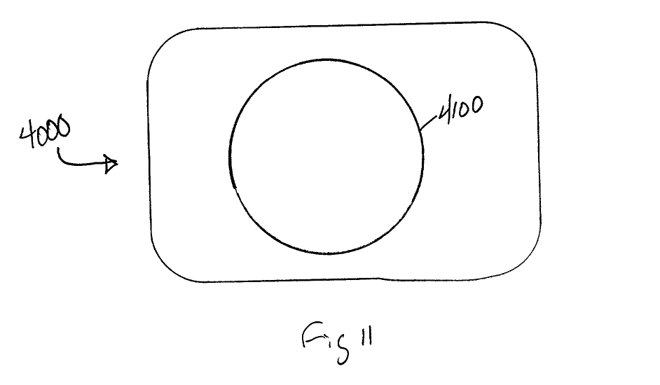

Referring now to FIG. 13, software components 20 associated with Processing tier 6000 need to have interfaces specified by Processing tier 6000 but also need to be able to access business software components 20 through business software component 20 interfaces. Processing tier 6000 provides for the instantiation and control of a process flow (or process model), including algorithmic processing. Algorithmic processing follows patterns defined by GPProcessingObject 6200 with required interfaces.

Processing tier 6000 comprises: GPProcessor 6100, defines the main processing interface; GPProcessingComponent 6200, handles the types of processing software components 20 that GPProcessor 6100 understands; GPHistoryModel 6300; GPProcessingModel 6400; and GPProcessingConnection 6500. Additionally, Processing tier 6000 aggregates IGCAttributes 3140, IGCObject 3130, IGCParents 3120, and IGCAssociations 3110. As used herein, connection components are understood to be connections between an output of one processing object to the input of another processing object that additionally validated that the output is compatible with the input.

GPProcessor 6100 is the main interface to Processing tier 6000 and handles all external communications, including managing process components along with their inputs, outputs, parameters, and how they are interconnected. This allows global setup of parameters and I/O components for a process. GPProcessor 6100 lets a client software component 20 communicate with a process, including software components 20 from one tier 30 to communicate with software components 20 of another tier 30.

In a preferred embodiment, GPProcessor 6100 tracks the requirements of filters in a processing model 31, modifies queries and windowedIO parameters to satisfy these requirements, monitors/optimizes the flow of data through a model 31, and performs other functions as required to manage the process flow. GPProcessor 6100 comprises IGCProcessor 6110 to manage external communications for a process model 31, including starting and stopping the process and modifying model 31. For example, a user can drop a query on IGCProcessor 6110, and IGCProcessor 6110 will modify the query to match the I/O requirements of software components 20 in process model 31. IGCProcessor 6110 also allows process software components 20 to be added to process model 31 and checks connections between software components 20 in model 31 for validity. In addition, outputs that are connected to sinks, i.e. persisted, are tracked and process model 31 that produced the output is attached as a history entry on the business software component 20 itself. In the preferred embodiment, IGCProcessor 6110 holds an abstract list of inputs, outputs, and parameters required by processing software components 20.

GPProcessingObject 6200 defines the types of processing software components 20 that the main processor GPProcessor 6100 understands, including filters, synchronization software components 20, sources, sinks, and graphical software components 20. In a preferred embodiment, processing software components 20 will have separate interfaces to allow setup of the inputs (connections), outputs (connections), and parameters (connections and constants), such as by way of example and not limitation tabs on a visual display page.

GPProcessingObject 6200 comprises: IGCProcessingObjectManager 6210, a common interface that all processing software components 20 aggregate. Additionally, GPProcessingObject 6200 comprises interfaces that must be inherited to ensure that the user software component 20 implements a predetermined set of methods when invoked, that store the name of the input (e.g., that can be used in the calculate function) and the type of software component 20 it supports, and that store the name of the output (e.g., that can be used in the calculate function) and the type of software component 20 it supports. Additionally, GPProcessingObject 6200 comprises IGCParameterObject 6250, IGCAttributes 3140, IGCObject 3130, IGCParents 3120, and IGCAssociations 3110 interfaces.

In the preferred embodiment, IGCProcessingObjectManager 6210 is the common interface that all processing software components 20 aggregate, and maintains the state machine which determines when a software component 20 is ready to fire a predetermined method and when it is ready to send data out. IGCProcessingObjectManager 6210 is dependent on IGCBaseProcessingObject 6220, a base processing software component 20 interface that must be inherited to ensure that the user software component 20 implements a predetermined function when invoked.

IGCInputObject 6230 stores the name of the input and the type of software component 20 it supports. IGCInputObject 6230 can be added to both a connection and a processing software component 20 in model 31. Windowed I/O parameter components and range validation components can be added to software components 20 to further describe input characteristics.

In a preferred embodiment, IGCInputObject 6240 is a business software component 20 and therefore includes the required business software component 20 interfaces. IGCInputObject 6240 interface also aggregates IGCType 1230 and IGCConnectionSink 1320. IGCOutputObject 6240 stores the name of the output and the type of software component 20 it supports. It can be added to both a connection software component 20 and a processing software component 20 in model 31. Windowed I/O parameter software component 20 can be added to it to further describe the output characteristics.

In the preferred embodiment, IGCParameterObject 6250 defines an acceptable input parameter. The parameter can change like an input value but can also be set to a constant value. IGCParameterObject 6250 can be added to both a connection software component 20 and a processing software component 20 in model 31. Windowed I/O parameter components and range validation components can be added to it to further describe the parameter characteristics.

IGCParameterObject 6250 is a business software component 20 and therefore includes the required business software component 20 interfaces and aggregates IGCType 1230 and IGCConnectionSink 1320. IGCParameterObject 6250 also aggregates GPHistoryModel 6300, GPProcessingModel 6400, and GPProcessingConnection 6500.

GPHistoryModel 6300 stores a complete process model 31 and query model 31 that was required to generate some output. For example, assuming a given input curve had some history model associated with it, one would have to query back into the input software components 20 recursively to get a complete history from raw data of the current software component 20. GPHistoryModel 6300 stores a history of how a software component 20 was generated. GPHistoryModel 6300 comprises IGCHistoryModel 6310, the base history software component 20 used to save a complete history of the process (for example, algorithms and inputs) used to generate an output software component 20. A user can add a process model 31 and a query model 31 to IGCHistoryModel 6310 to save a history of how an output software component 20 was generated. IGCHistoryModel 6310 is a business software component 20 and therefore includes the required business software component 20 interfaces and aggregates GPBase 1200 interfaces such as type, data, and time interfaces.

GPProcessingModel 6400 consists of processing software components 20 and connection software components 20 used to form a specific processing flow. GPProcessingModel 6400 can be persisted and re-used, for example, with different input queries or stored with history attachments to output software components 20. GPProcessingModel 6400 comprises: IGCProcessingModel 6410, the process model comprising process software components 20, connections, and IGCType 1230; and IGCProcessingObject 6420, the base software component 20 for all processing software components 20.

IGCProcessingModel 6410 is a business software component 20 and can be persisted and re-used, for example, with different input queries or stored as a history attachment to output software components 20.

IGCProcessingObject 6420 is a business software component 20 that can represent any type of processing software components 20. IGCProcessingObject 6420 holds an interface pointer to the processor to which it is connected for data output. The state of the software components 20 is maintained for the length of a transaction.

GPProcessingConnection 6500 provides connections between processing software components 20. There is one connection software component 20 in the process model 31 for every input, output, and parameter that a processing software component 20 requires. Outputs that are not connected are dead-ended. Parameters can be setup as constants, e.g. in a property sheet, or connected to a source and queried.

In a currently preferred embodiment, there will be one IGCProcessingConnection 6510 in a process model 31 for every input, output, and parameter that a processing software component 20 requires. Inputs that are not connected are queried. Outputs that are not connected are dead-ended. IGCProcessingConnection 6510 parameters can be set up as constants, for example in their property sheets, or, if not connected, they are queried. IGCProcessingConnection 6510 is a business software component 20 and includes the business software component interfaces and aggregates IGCType 1230 and IGCConnectionSink 1320. A base type can be used for more flexibility. For example, an input software component 20 of a given predetermined type “GCGr” must be connected to an output component of type “GCGr” and an input type of “GCGr” can also be connected to an output type of “GCCx” or “GCCy.”

IGCProcessingConnectCondition 6520 interface serves as a connector between processing software components 20 but allows a conditional expression that determines whether the processing branch continues. The conditional software component 20 holds the qualifying condition for the connection. There can be more than one condition for a connection, and there can be more than one condition per outgoing branch. In a preferred embodiment, a “true” response indicates the processing branch is live.

IGCProcessingConnectCondition 6520 is a business software component 20 and therefore includes the required business software component 20 interfaces. In addition, IGCProcessingConnectCondition 6520 interface also aggregates IGCType 1230, IGCConnectionSink 1320, and IGCConnectionSource 1310.

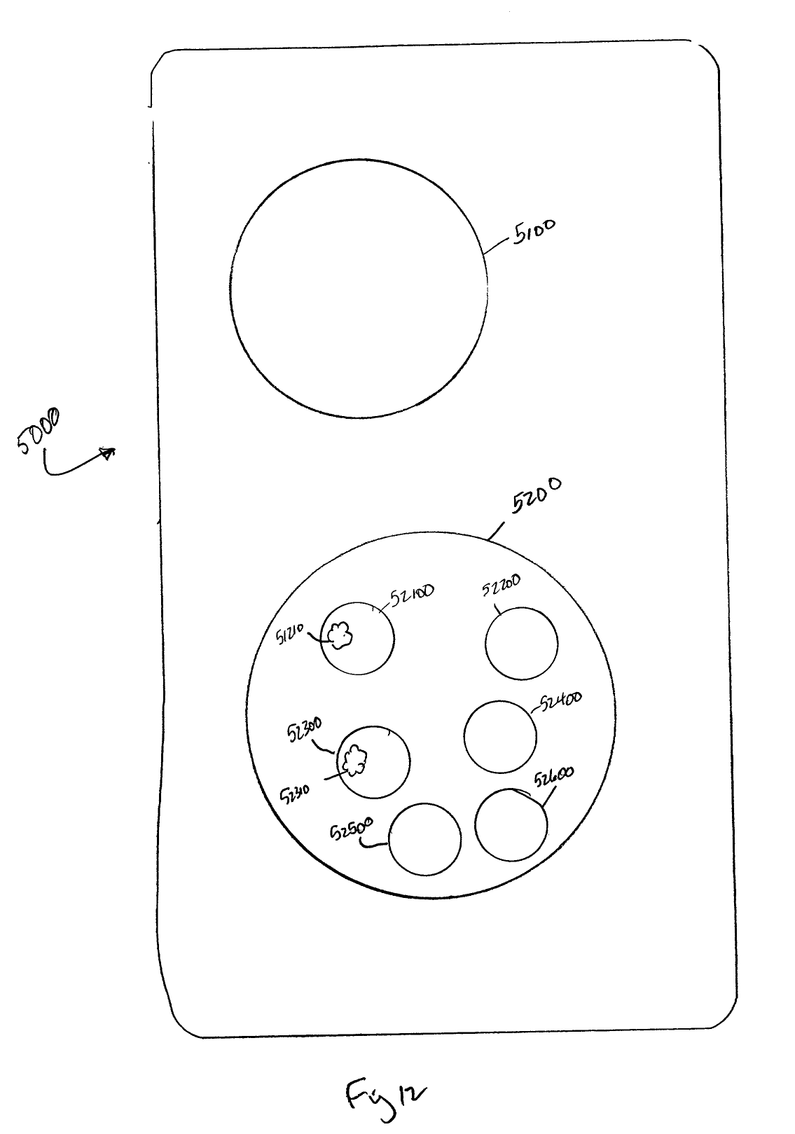

Referring now to FIG. 14, Visual tier 7000 provides display of and user interaction with information. In a preferred embodiment, Visual tier 7000 architecture is based on a Model-View-Controller design pattern. A Visual tier 7000 visual software component 20 comprises visual model 7001 (identified by IGCViewModel 7210), view 7002 (typically a full ActiveX control which exposes IGCView 7110 and IGCBaseView 7120), and controller 7003 (identified by IGCViewController 7310). Visual model 7001, view 7002, and controller 7003 are connected using messaging such as from GPConnection 1300, GPMessage 2100, and GPEventHandler 1400, and each can have one or more message handlers attached to provide additional behavior. Additionally, visual software components 20 have a connection sink.

Stock visual model 7001 and controller 7003 software components 20 are similar and comprise event handler, connection source, and connection sink interfaces. Stock visual model 7001 and controller 7003 software components 20 differ in behavior because they have different message handlers attached. Views 7002 are custom software components 20 (usually full ActiveX controls), but they are similar to visual models 7001 and controllers 7003 in views 7003 aggregate interfaces that implement stock view behavior including event and connection handlers.

In a preferred embodiment, a visual software component 20 or controller 7003 comprises a custom ActiveX control for a view 7002 as well as stock visual model 7001 and controller 7003 software components 20. In a currently preferred embodiment, visual model 7001 and controller 7003 are stock software components 20 whose behavior is modified by attaching behavioral components to them. View 7003 is a composite of several software components 20, but requires more attention to customize behavior. In a currently preferred embodiment, visual model 7001, view 7002, and controller 7003 are COM software components 20.

Visual tier 7000 also comprises: GPView 7100, that provides visual representation of business software components 20; GPViewModel 7200, that handles data and computational logic; and GPViewController 7300, that manages user interaction.

GPView 7100 implements the visual portion of the pattern and provides visual representation of business software components 20. GPView 7100 comprises: IGCView 7110, that contains stock view behavior; and IGCBaseView 7120, that forces the definition of required customized behavior for each view 7002. Views 7002 (for example, log viewers or graphical displays) must aggregate IGCView 7110, which exposes the same set of interfaces that stock visual models 7001 and controllers 7003 expose for event handling and connections. However, IGCView 7110 also provides basic drag-and-drop behavior with the addition of the standard OLE interfaces for drag-and-drop, as these terms are readily understood by those of ordinary skill in the programming arts.

IGCBaseView 7120 forces the definition of required customized behavior for each view 7002. IGCBaseView 7120 comprises: InitializeModel( ) 7121, to communicate a view's 7002 data requirements to a visual model 7001; UpdateView( ) 7122, to redraw view 7002 as needed; and GetObject( ) 7123, to find out what the current software component is. Views 7002 must implement IGCBaseView 7120. There is no stock implementation for IGCBaseView 7120 because each view 7002 will have different requirements for this interface. InitializeModel( ) 7121 has the custom logic to communicate the view's 7002 data requirements to visual model 7001. UpdateView( ) 7122 is called by the stock UpdateViewHandler software component 20 to re-draw view 7002. GetObject( ) 7123 must implement hit-testing, and it is used by IGCView's 7110 drag-and-drop implementation.

GPViewModel 7200 implements the visual model 7001 part of the model-view-controller pattern and is responsible for managing business software components 20 that are being visually manipulated. GPViewModel 7200 contains IGCViewModel 7210.

Visual model 7001 exposes IGCViewModel 7210, IGCConnectionSink 1320, and IGCConnectionSource 1310. IGCViewModel 7210 serves as a wrapper for a business model 31 and provides methods for registering an external software component 20. IGCConnectionSink 1320 receives messages which are routed to appropriate message handlers. Outbound messages are sent out through IGCConnectionSource 1310. Message handler software components 20 are attached via IGCEventHandler 1410.

IGCView Model 7210 contains a pointer to the business model 31 that it wraps. In general, changes to business model 31 generate update messages bound for views 7002 with which the business model 31 is registered.

IGCViewModel 7210 and IGCViewController 7310 are stock software components 20. A custom view 7002 is a full Active Template Library(“ATL”) control that aggregates stock component IGCView 7110 to create view 7002. Additionally, view 7002 must expose and implement a base view interface. Further, View tier 7000 interfaces may be provided a user on a read-only mode, whereby the viewer can be specified to allow read-only access to the system; an editing mode, whereby users may edit models as well as view them; or configurably in either read-only or editing modes.

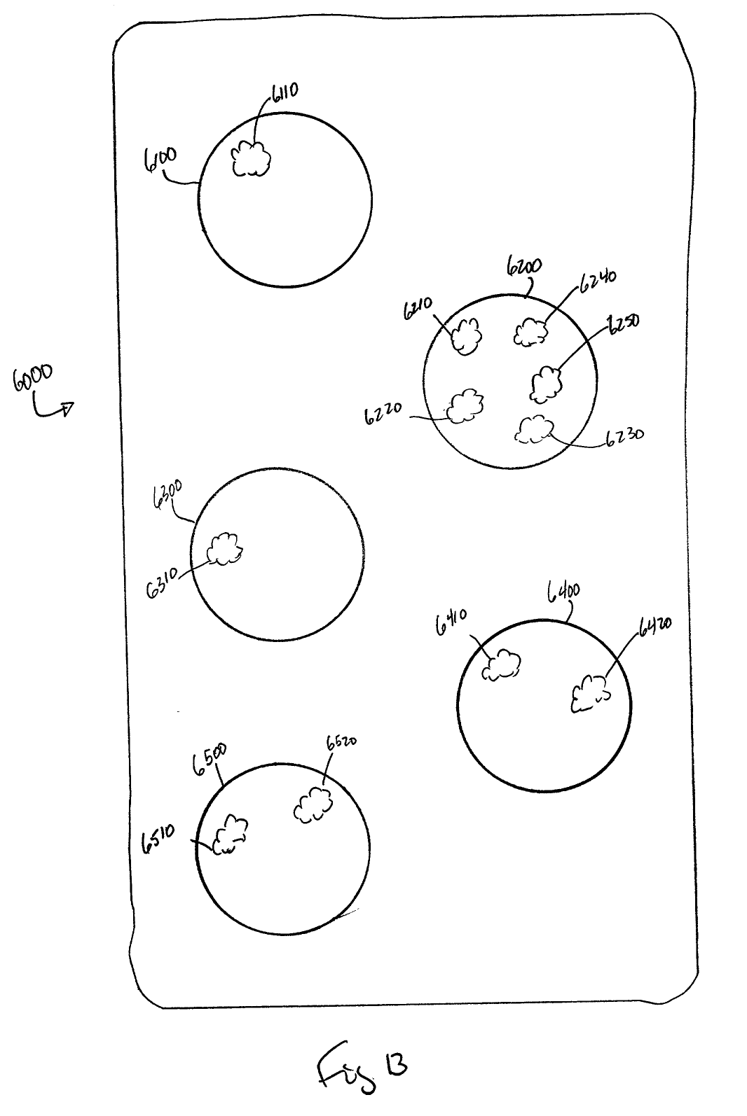

Referring now to FIG. 15, the Model-View-Controller (“MVC”) design pattern comprises three logical sub-components: visual model 7001, view 7002, and controller 7003. Visual model 7001 contains data and computational logic. View 7002 presents visual model 7001, or a portion of it, to users. Controller 7003 handles user interaction, such as keystrokes and pointer device-generated inputs. The basic MVC design pattern is used by the present invention for Visual tier 7000 software components 20 such as log viewers or editors. Generally, a view 7002 must be associated with a visual model 7001 so that the visual model 7001 can notify the view 7002 that it needs to update itself. Visual model 7001 must have some sort of registration mechanism for views 7002 to use to request the update notices, and view 7002 must have an update mechanism for visual model 7001 to use.

A view 7002 will also be associated with a controller 7003. User interaction, initially captured by view 7002, is forwarded to controller 7003 for interpretation. Controller 7003 then notifies visual model 7001, if necessary, of any action that should be taken as a result of the interaction.

Although FIG. 15 shows the main lines of communication between the three MVC sub-components, other interactions between these components may also exist. For example, view 7002 must get data it needs to present from visual model 7001, and controller 7003 may not need to request action of visual model 7001 to process some user interaction events. By way of further example and not limitation, view 7002 may need to update because of some event that does not result in an update notification from visual model 7001.

Referring now to FIG. 16, template software components 20 found within Template tier 8000 provide implementation of persistence, collections, and iterators for standard software components of the present invention, by way of example and not limitation such as those used by the C++ language. Template software components 20 may be used in software component 20 implementation to facilitate the implementation of standard functionality and to reduce the maintenance effort for extending the functionality of software components 20.

In a preferred embodiment, the present invention template system is a set of C++ classes that support some of the functionality of the present invention system and are not COM software components 20. This means that the template software components 20 do not have interfaces and are not implemented through COM logic. Instead, they are implemented using standard implementation techniques for C++ templates. In a similar manner, templates may be provided for other languages such as, by way of example and not limitation, JAVA, FORTRAN, assembler, SQL, or any combination thereof.

Template tier 8000 comprises: GCPersistStreamImpl 8100, that provides C++ implementation of persistence, e.g. to allow reading and writing of data; GCCollectionImpl 8200, that provides C++ implementation of collections, e.g. to allow associated business software components 20 to be grouped in a set (collection); GCIterator 8300, that provides C++ implementation of iteration, e.g. moving through a collection of software components 20; and GCTraversingIterator 8400, that provides C++ implementation of traversing iteration, including movement through a collection in a particular order. GCTraversingIterator 8400 is dependent on GCIterator 8300 and implements methods with the same names as those in GCIterator 8300.

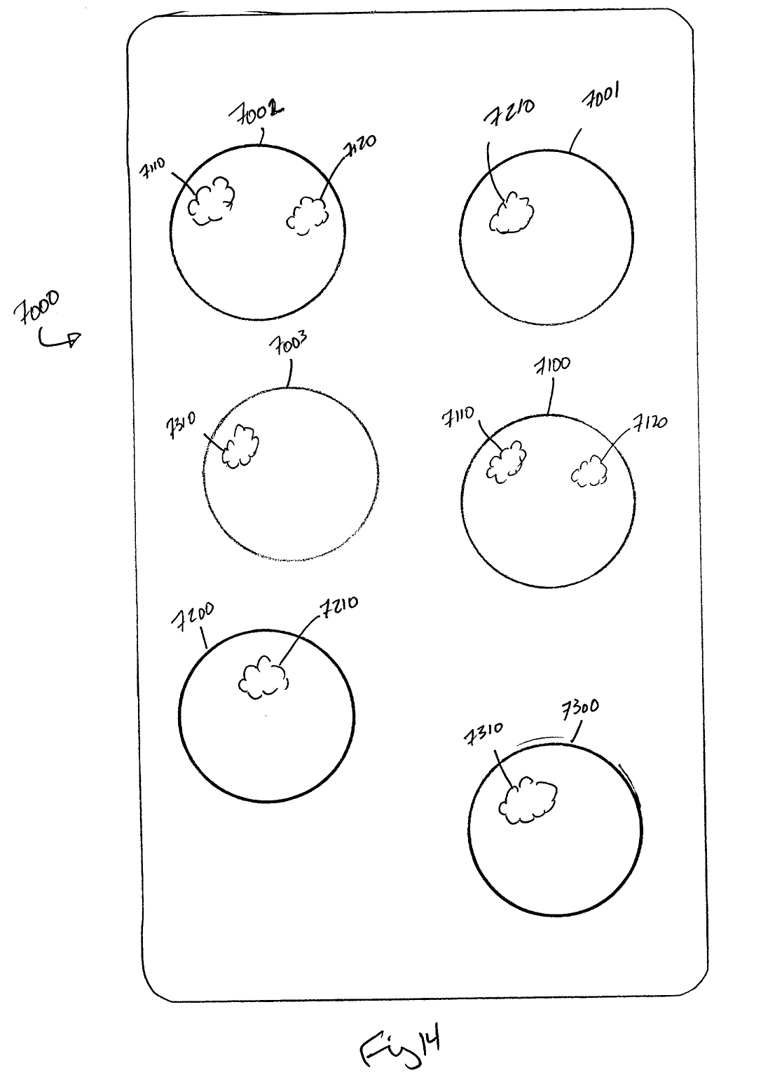

Referring now to FIG. 17, Business Rules tier 9000 is used to facilitate use of business rules, which are conditions and tests to determine whether it is valid for one business software component to have another business software component 20 added to its associations. For example, business rules may dictate that an oil field may have many wells associated with it, but a well may only be associated with one oil field. Business rules are also used to enforce cardinality.

Business Rules tier 9000 comprises GPBusinessRules 9100 which provides the interface through which business software component 20 associations are validated and enforced.

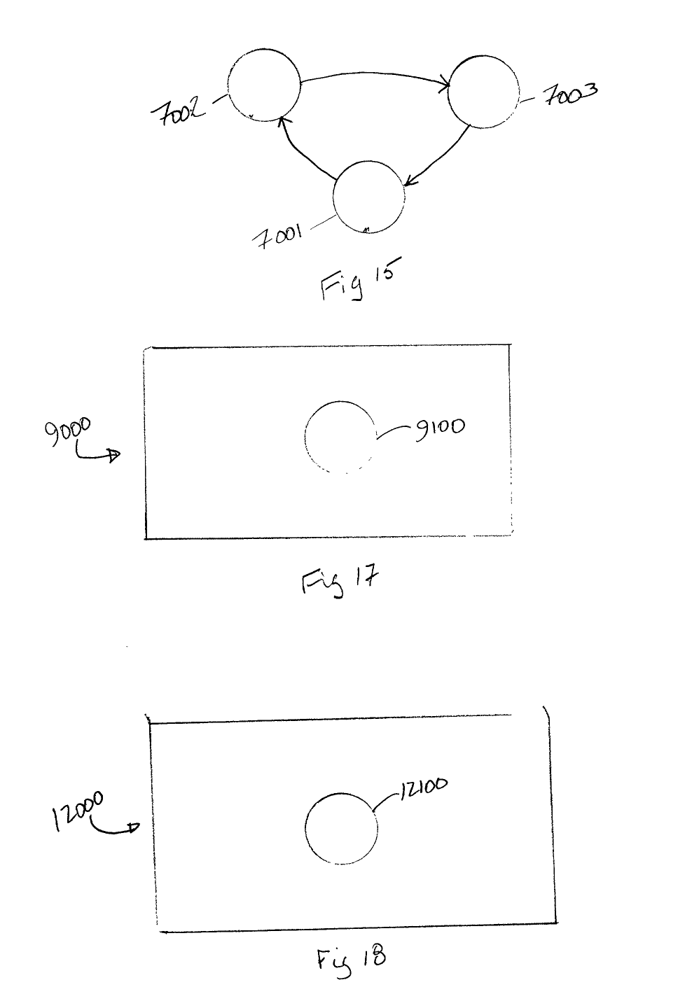

Referring now to FIG. 18, Interceptor tier 12000 intercepts and controls messages between software components 20 or calls to a software component's 20 interface. An intercepted message or interface call may be validated, interrogated, and acted upon by callbacks registered with an interceptor software component 20 before it is transmitted to the target software component 20. This technique allows for validation and control of the disposition of messages and interface calls without modifying the source or target software components 20. Callbacks have complete control over the disposition of the message or interface call and may thwart the intended activity.

Interceptor tier 12000 comprises GPInterceptor 12100 which intercepts and controls messages, including interfaces to allow a user to intercept and control messages between software components 20 or calls to a software component's 20 interface.

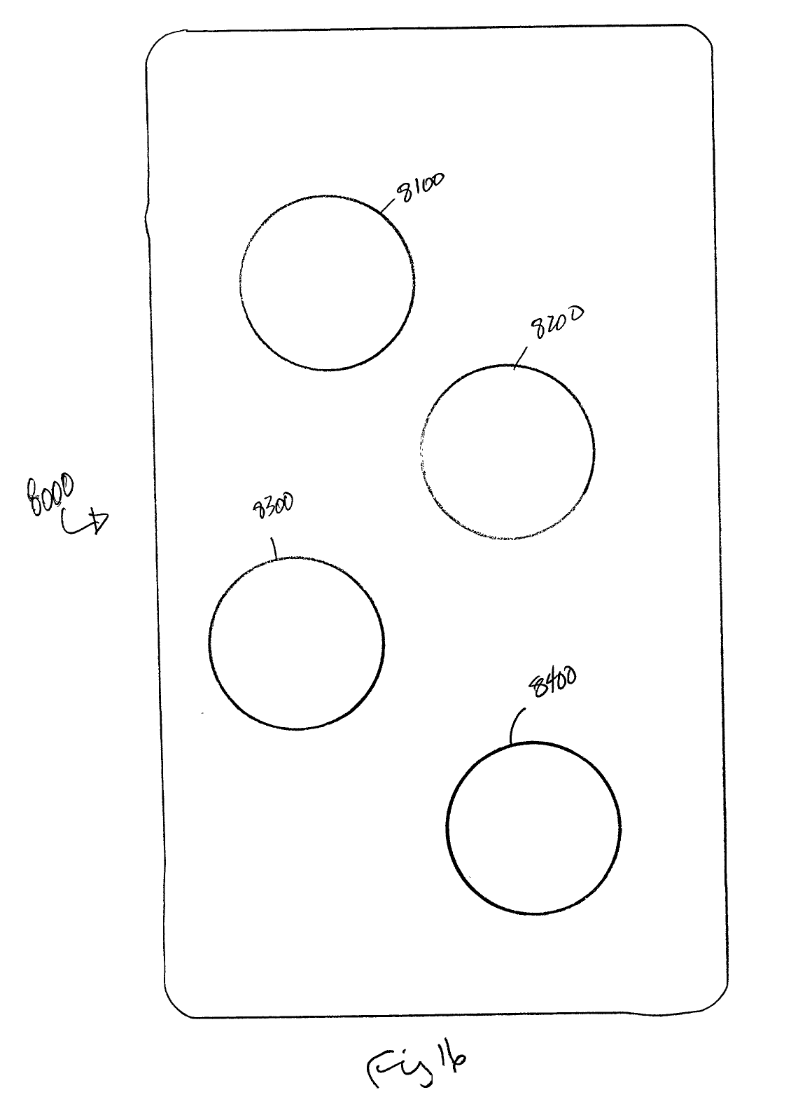

Referring now to FIG. 19, Application tier 13000 provides a method for creating applications that use the behavior of the present invention system, including the asynchronous behavior of the preferred embodiment. Software components 20 may be created and registered and service components connected to, thus establishing dependencies and communication links before an application begins responding to events.

Application tier 13000 comprises GPApplication 13100 that allows a user to create applications that use the present invention's preferred embodiment asynchronous behavior. Although GPApplication's 13100 interface contains no methods or properties, it aggregates IGCEventHandler 1410, IGCMessageQueue 2210, IGCPersist 5110, and IGCRouter 2310.

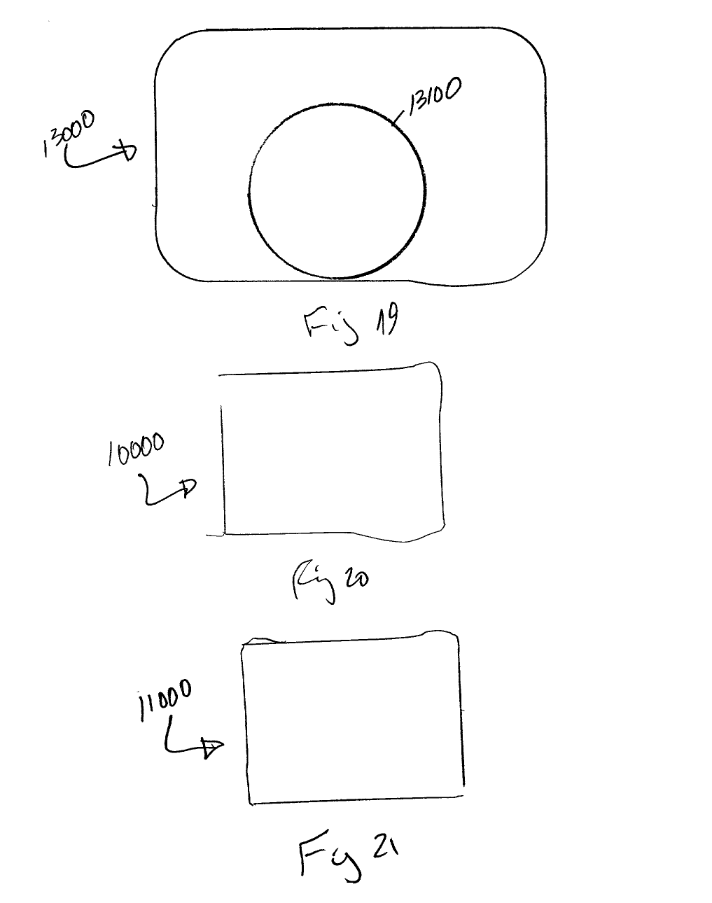

Referring now to FIG. 20, tiers 30 may be defined and implemented which are not integrated into a final application but rather are present to aid development.

In the preferred embodiment, Wizard tier 10000 software components 20 are wizards, as that term is readily understood by those of ordinary skill in the software programming arts, that assist a developer in creating software components 20. Wizard tier 10000 is one of the present invention's supporting tiers 30 and does not provide additional behavior to software components 20, but assists developers in quickly creating standard software components 20. Wizards are developed for frameworks 40 to insure that the proper framework 40 interfaces are implemented for a software component 20. In the preferred embodiment, most wizards are specific to the Microsoft C++ development environment, with these wizard presenting questions to the developer and generating a set of C++ classes and methods based on the developer's responses, by way of example and not limitation such as an ATL Project wizard similar to the Microsoft standard Visual Studio ATL Project Wizard. However, wizards are not limited in their actions or outputs to C++, and can include, by way of example and not limitation, wizards to generate ASCII text files, project files, source code in computer languages other than C++ such as JAVA, or any combination thereof.

Referring now to FIG. 21, also an integral part of the development process, Testing tier 11000 provides a set of rules and required activities that define acceptable tests of software components 20. Coupled with the requirements for developing software components 20, Testing tier 11000 rules and activities are defined by and derived from those same requirements. In the preferred embodiment, a test software component 20 implementing these rules and activities is developed in parallel with development of software components 20 for a given framework 40 to exercise the finished software components 20 in that framework 40. This insures the conformity of the finished software components 20 with the stated requirements.

In the preferred embodiment, at least one test software component 20 (created as a “test harness”) is developed per framework 40. The test harness inspects a software component 20 to insure that it has implemented all the required interfaces for its framework 40 and that the interfaces function properly. In the preferred embodiment, the test harness interface includes functionality for running test scripts and storing test results. The test results may include pass/fail information, time/date stamp, and specific results of individual tests, for example, the CLSID of software components 20.

Every test harness must also implement an interface comprising specific test criteria and execution methods for software components 20 in a framework 40. The test criteria are derived from the requirements and design documents created for the software components 20 to be tested, and compiled into a test harnesses.

Tiers 30 in the present invention may be extended as a user desires, such as by adding additional tiers 30. By way of example and not limitation, a user may desire Graphics tier 30, Plotting tier 30, and Security tier 30, or any other tier 30 to address a given functionality required, e.g. for a system's requirements.

In the operation of the preferred embodiment, referring generally to FIG. 6, to create a software application a set of application requirements is determined 70, either manually, heuristically, automatically, or by any combination thereof. Using predetermined N-tier architecture rules and optional wizards, a system designer determines 72, 74 a list of required models 31 and software components 20 to satisfy the application requirements. The list of required models 31 and software components 20 are logically grouped 72 into one or more packages 42 and the packages 42 associated with tiers 30.

Using the predetermined N-tier architecture rules, the system designer then determines 76 if each software component 20 in each tier 30 is available in an inventory 700 of software components 20. Each software component 20 found in inventory 700 is then associated with an appropriate tier 30 if that software component 20 is required. The N-tier architecture rules will further comprise rules for restructuring software components 20 in inventory 700 to ensure conformance with all other application design rules while retaining the original intent of the requirement. Similarly, the N-tier architecture rules may contain rules on expanding the architecture by adding one or more tiers 30 to accommodate new or restructured software components 20.

Each software component 20 not found in inventory 700 is located elsewhere, purchased, or created 80 and added to inventory 700 according to rules for inclusion defined by the N-tier architecture rules. These rules may include rules on assessing each new and/or restructured software component 20 for suitability 82, 84, 86 to become part of the software inventory 700. By way of example and not limitation, this may include rules that allow that software components 20 that are so specific they can only be used in the current application are not added to inventory 700.

After at least one software component 20 exists for each requirement, the present invention's an application is created 80 using the predetermined N-tier architecture rules that include rules on defining and implementing linkages between the tiers 30.

After an application is created, the all software components 20 to be used in the application may be tested.

Once all requirements have software components 20 to satisfy the requirements, and the software components 20 have been associated with tiers 30, the tiers 30 are assembled and compiled into a stand-alone, executable program. As will be understood by those of ordinary skill in the software programming arts, assembly and compilation may occur in many equivalent forms including by way of example and not limitation P-code or pseudo code, interpreters, dynamically linked runtime libraries, just-in-time runtime techniques, monolithic executables, or any combination thereof. Such assembly and compilation may be accomplished at run-time to form new unique applications on-the-fly.

Once all requirements are satisfied, i.e. software components 20 are acquired from inventory 700 or elsewhere and associated into tiers 30, a testing tier 30 may be defined and implemented to accomplish system level testing and validation. Alternatively, testing tier 30 may be defined when all requirements are identified, and then developed in parallel with software component 20 assembly.

The present invention can be embodied in the form of computer-implemented processes and apparatuses for practicing those processes. Various aspects of the present invention can also be embodied in the form of computer program code embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted as a propagated computer data or other signal over some transmission or propagation medium, such as over electrical wiring or cabling, through fiber optics, or via electromagnetic radiation, or otherwise embodied in a carrier wave, wherein, when the computer program code is loaded into and executed by a computer, the computer becomes an apparatus for practicing the invention. When implemented on a general-purpose microprocessor, the computer program code segments configure the microprocessor to create specific logic circuits to carry out the desired process.

Therefore, a system for designing and/or implementing a software application can comprise numerous means for creating software components 20 and tiers 30, and assembling the application, all of which will be familiar to those of ordinary skill in the computer arts, including, by way of example and not limitation, keyboards, mice, drag-and-drop interfaces, text editors, graphical editors, OLE interfaces, and the like or any combination thereof. These means may further comprise manual means, heuristic means, automated means, and the like, or any combination thereof, such as expert system driven or implemented designs, neural networks, and the like.

It will be understood that various changes in the details, materials, and arrangements of the parts which have been described and illustrated above in order to explain the nature of this invention may be made by those skilled in the art without departing from the principle and scope of the invention as recited in the following claims.

What is claimed is:

1. A computing system for creating an extensible N-tiered software application, comprising:
a. at least one processing unit;
b. at least one memory store operatively connected to the processing unit;
c. extensible N-tiered creation software, executable within the at least one processing unit, comprising a plurality of predetermined extensible N-tier architecture rules; and
d. at least one extensible tier, capable of residing in the memory store, further comprising:
i. a framework that specifies a basic design structure for software components categorized as belonging to the extensible tier, the framework further comprising base software components and a set of standard interfaces for any software component categorized as belonging to the tier; and
ii. a logically grouped set of a predetermined number of executable software components compliant with the tier framework, each software component further capable of communicating with at least one other software component.

2. The computing system of claim 1 further comprising a communications network, operatively in communication with the processing unit, the communications network selected from the group of networks consisting of local internal networks, local area networks, asynchronous networks, synchronous networks, and wide area networks.

3. The computing system of claim 1 wherein communication between the software components comprises asynchronous communications.

4. The computing system of claim 1 further comprising an inventory of software components.

5. The computing system of claim 1 wherein the at least one extensible tier is a set of extensible tiers, further comprising a set of logical connections comprising sequencing and messaging information between a first one of the extensible tiers and at least one other tier of the extensible set of tiers, whereby each tier in the extensible set of tiers is capable of communicating with any other tier through one or more tier interfaces.

6. The computing system claim 5 wherein the set of extensible tiers comprises a base tier comprising a base tier framework, the base tier framework comprising:
a. at least one collection interface for collecting software components, including software components which are normally aggregated into other software components;
b. at least one connection interface for connecting software components as sources or sinks of information;
c. at least one messaging interface comprising message-based behavior; and
d. at least one control interface for controlling devices.

7. The computing system of claim 5 wherein the set of extensible tiers comprises a business rules tier, a processing tier, a data tier, a messaging tier, a business objects tier, a visual tier, a base tier, a real-time device tier, an interceptor tier, and an application tier.

8. The computing system claim 7 wherein the processing tier further comprises a framework comprising:
a. an interface capable of handling processing components associated with the processing tier;
b. an aggregation interface to aggregate a predetermined number of software component attributes;
c. a query interface comprising a query modification interface; and
d. a predetermined number of windowed input/output parameters to satisfy processing tier requirements;
e. whereby a processing tier software component can manage process flows and monitor and/or optimize flow of data through a model.

9. The computer system of claim 8 further comprising a tracking interface to track processing model filter requirements.

10. The computer system of claim 9 wherein the processing components comprise filters, synchronization components, sources, sinks, and graphical components.

11. The system of claim 7 wherein the data tier comprises a data tier framework and provides data persistence services for a predetermined set of software components and access to data, the data tier framework further comprising:
a. a data modification interface whereby data may be written to and read from a data source; and
b. a data access interface whereby access may be provided to specific types of data.

12. The system of claim 7 wherein the messaging tier further comprises a messaging tier framework and messaging software components to convey information from a source of messages to a recipient of messages, the messaging tier framework further comprising:
a. a message generation interface;
b. a message queuing interface;
c. a message routing interface;
d. a message text management interface;
e. a message routing interface whereby one or more software components that will receive a message may be specified; and
f. a message queue interface whereby information about a specific queue may be specified;
g. wherein the messaging software components control message queuing and notification, and support message generation for different types of messages.

13. The method of claim 12 wherein the messaging tier interface supports asynchronous messaging.

14. The system of claim 7 wherein the business components tier further comprises:
a. at least one business software component, the business software component comprising a general purpose data container providing storage for and access to information, the business software component further encapsulating attributes comprising data and behavior for a business entity; and
b. a business software component framework, comprising:
i. a model comprising a collection of related business software components to reflect a real-world business entity; and
ii. a binary large object to allow storage of large amounts of data within the business software component.

15. The system of claim 14 wherein at least one business software component has an attribute that is other business software component.

16. The system of claim 14 wherein the at least one business software component is a composition defining a static model whereby the relationship between the business software component and an attribute component is not an association enforced by business rules.

17. The system of claim 14 wherein the model further comprises a set of business software components model interfaces that the business software components aggregate to achieve specific functionality.

18. The system of claim 17 wherein the business software components model interfaces comprise:
a. an association interface whereby business software components may be associated with other software components;
b. a relationship interface whereby hierarchical relationships with other software components may be established and maintained;
c. a data dump interface whereby contents of a software component may be selectively retrieved; and
d. a name interface whereby persistable attribute names may be retrieved.

19. The system of claim 7 further comprising a visual tier to provide display of and user interaction with information, the visual tier using a model, view, and controller design pattern comprising:
a. a modeler comprising data and computational logic to handle user interaction, the modeler further comprising an event handler, a connection source, and a connection sink;
b. a viewer comprising data and computational logic to present at least a portion of a model perceptively to a requester, the view component further comprising an event handler and a connection source; and
c. a controller comprising data and computational logic to handle requestor interaction, the requestor interaction further comprising actions from an input device, the controller component further comprising an event handler, a connection source, and a connection sink;
d. wherein the modeler, the viewer, and the controller may utilize a messaging tier whereby each of the modeler, the viewer, and the controller can have one or more message handlers attached to provide additional behavior, the modeler and the controller having different message handlers attached to effect differing behavior.

20. The system of claim 19 wherein the visual tier further comprises:
a. a read-only mode, whereby the viewer can be specified to allow read-only access to the system; and
b. an editing mode, whereby users may edit models as well as view them;
c. wherein an N-tiered application may selectively comprise either the read-only mode, the editing mode, or both on a user by user basis.

21. The system of claim 7 wherein the real-time device tier further comprises:
a. a communication interface; and
b. an event-handling interface;
c. whereby a real-time device can communicate with connected software components to support communication with and event handling for a real-time device.

22. A method for generating a software application in a computing system for creating an extensible N-tiered software application comprising at least one processing unit; at least one memory store operatively connected to the processing unit; extensible N-tiered software, comprising a predetermined set of software component rules, tier rules, and application assembly rules, the N-tiered software being executable within the at least one processing unit; an inventory of executable software components, each software component further comprising a given structure and an external interface and further capable of communicating with at least one other software component; and a predetermined set of initial extensible tiers capable of residing in the memory store, each tier of the predetermined set of extensible tiers having a given structure, the set of extensible tiers further comprising a logically grouped set of a predetermined number of the executable software components, the method comprising:
a. determining a set of application requirements;
b. for each of the set of application requirements, reviewing the inventory of software components for software components that match at least one of the set of application requirements;
c. for each application requirement in the set of application requirements for which a software component match does not exist in the software component inventory, obtaining a software component that does match that application requirement;
d. defining a set of tiers to logically model the application requirements;
e. selecting tiers from the predetermined set of tiers to satisfy the defined set of tiers;
f. for tiers not within the predetermined set of tiers needed to satisfy the defined set of tiers, creating new tiers;
g. associating each of the matching software components with at least one tier of the defined set of tiers according to a framework associated with that tier; and
h. creating a software application by assembling the predetermined set of tiers according to the application assembly rules;
i. whereby the software application satisfies the set of application requirements.

23. The method of claim 22 wherein obtaining a software component that does match that application requirement further comprises selectively modifying an existing software component or procuring and selectively modifying a new software component from an independent source of software components to comply with a tier's framework requirements.

24. The method of claim 22 further comprising:
a. examining the obtained software components for incorporation into the software component inventory according to predetermined incorporation criteria; and
b. storing the obtained software component in the software component inventory if it meets the incorporation criteria.

25. The method of claim 22, wherein at least one of the software components is a business software component, further comprising automatically retrieving composite software components along with an associated business software component when the associated business software component is retrieved from a persistent store.

26. The system of claim 22 wherein composite components are not created when a new business software component is created but instead where it is the responsibility of the creator to create a composite component and set it into the composing component.

27. The method of claim 22 wherein software components and tiers are combined at run-time to form new, unique applications on-the-fly.

28. The method of claim 22 further comprising:
a. defining a testing tier;
b. testing a final model using the testing tier; and
c. correcting errors within the executable software components within the final model.

29. The method of claim 22 wherein associating is accomplished using a graphical user interface.

30. The method of claim 22 wherein creating new tiers further comprises:
a. examining a requirement;
b. determining if a current framework is adaptable to accommodate the requirement;
c. using the current framework if it is adaptable to accommodate the requirement;
d. defining a new framework to accommodate the requirement is no current framework is adaptable or otherwise accommodates the requirement; and
e. creating a new tier with the new framework.

31. The method of claim 22 further comprising removing a tier, the step comprising:
a. examining current requirements;
b. for each current tier, determining if at least one other tier satisfies the requirements;
c. if so, combining those tiers;
d. for each remaining tier, determining if the tier is no longer needed to satisfy at least one requirement; and
e. if so, remove the no longer needed tier.

32. The method of claim 22 further comprising defining an initial set of tiers.

33. The method of claim 32, wherein the initial set of tiers comprise a business rules tier, a processing tier, a data tier, a messaging tier, a plotting tier, a business objects tier, a visualization tier, a base tier, a real time device tier, an interceptor tier, and an application tier.

34. The method of claim 33 wherein defining a business rules tier framework further comprises:
a. defining a set of business rules;
b. defining a predetermined set of properties and methods which can be used to determine whether a first software component violates the business rules by being associated with a second software component;
c. defining a predetermined set of properties and methods which can be used to determine a type of each associated child software component;
d. defining a predetermined set of properties and methods which can be used to determine a type of each associated parent software component; and
e. defining a predetermined set of properties and methods which can be used to determine whether a first software component having a specific type violates the business rules by being associated with a second software component having a specific type.

35. The method of claim 33 further comprising allowing building of business software components as general purpose, reusable data containers, whereby data and behaviors in a business software component are hidden from other software components, other components are kept from having to know the business software component's internal structure and implementation details, and data integrity checks are allowed to occur at the business software component level.

36. The method of claim 35 further comprising collecting business software components into a heterogeneous collection model that represents a real-world business entity.

37. The method of claim 35 wherein collecting business software components uses a generalized collection interface to collect other business software components.

38. The method of claim 33 further comprising specifying a framework for the real-time device tier to support communication with and event handling for at least one real-time device, the framework comprising properties and methods that support a predetermined communication interface and a predetermined event-handling interface whereby a real-time device can communicate with connected software components.

39. The method of claim 33 wherein the interceptor tier comprises properties and methods to allow interception and control of messages passed between software components or calls to a software component's interface, whereby an intercepted message or interface call may be validated, interrogated, and acted upon by callbacks registered with the interceptor tier before the intercepted message or interface call is transmitted to a target software component, allowing validation and control of the disposition of the message or call to the software component's interface to occur without modifying a source or the target software component.

40. The method of claim 39 further comprising:
a. specifying a method for registering a callback with the interceptor;
b. specifying a method for canceling registration of a callback; and
c. specifying a method for creating an instance of a software component.

41. The method of claim 33 further comprising:
a. specifying a method within the application tier for creating applications that use asynchronous behavior;
b. specifying how software components are created and registered; and
c. specifying how service components are connected;
d. whereby dependencies and communication links are established before an application begins responding to events.

42. The method of claim 33 further comprising specifying a wizard tier comprising one or more wizards developed for frameworks to insure that proper framework interfaces are implemented for a software component associated with a tier, whereby the wizard tier may be used during a development process.

43. The method of claim 33 further comprising:
a. specifying a set of rules and required activities for the testing tier; and
b. using the rules and required activities to define acceptable tests of a software component;
c. wherein the rules and activities comprise at least one test harness to run a test script and store test results, whereby the test harness inspects a software component associated with f a framework to insure that the software component has implemented all the required interfaces for that framework and that the interfaces function properly.

44. The method of claim 43 wherein the rules and required activities are defined by and derived from the requirements for developing a software component.

45. The method of claim 33 further comprising providing a template tier, the template tier comprising templates comprising predetermined software language implementations of persistence, collections, and iterators for software components within the template tier, whereby the templates are used in component implementation to facilitate the implementation of predetermined functionality and to reduce the maintenance effort for extending the functionality of components.

46. A method for generating an application comprising software components, each software component having a given structure, comprising:
a. determining an application's system requirements;
b. with the system requirements, creating one or more tiers from an initial set of tiers to create a model design, each tier being responsible for providing a discrete set of application programmatic responsibilities, until all the tiers collectively satisfy the application's system requirements;
c. for each tier, creating a framework, comprising:
i. defining an architected context for software components to be associated with that tier, comprising specifying a basic design structure, including base components, of that tier;
ii. defining a logical grouping of executable software components to be associated with that tier to implement the tier; and
iii. specifying a set of standard interfaces for any software component categorized as belonging to that tier;
d. for each framework:
i. checking each required software component for existence in an inventory of software component components;
ii. selecting for use within a tier software components within each framework that are also present in the inventory that satisfy the framework; and
iii. for each required software component not present in the inventory, obtaining a software component to satisfy the requirement;
e. for each tier:
i. assembling all software component components associated with the tier into that tier; and
ii. defining the sequencing and data relationships between that tier and each other tier with which that tier needs to be sequenced or exchange data; and
f. packaging all the tiers that collectively satisfy the application's system requirements into an invocable application.

47. The method of claim 46 further comprising:
a. defining a testing tier;
b. testing the invocable application using the testing tier; and
c. correcting errors within the invocable application.

48. The method of claim 46 wherein defining the sequencing and data relationships between that tier and each other tier with which that tier needs to be sequenced or exchange data are accomplished via a graphical user interface.

49. A computer program embodied within a computer-readable medium created using the method of claim 22.

50. A computer program embodied within a computer-readable medium created using the method of claim 46.
